(19) United States
(12) Patent Application Publication
(10) Pub. No.: US 2008/0156964 A1
(43) Pub. Date: Jul. 3, 2008

(54) Method and Apparatus for Detecting Ultra-Short Light Pulses of a Repetitive Light Pulse Signal, and for Determining the Pulse Width of the Light Pulses

(75) Inventors: Wei-Hua Guo, Dublin (IE); John Francis Donegan, Kildare (IE); Ann Louise Bradley, Dublin (IE); Michael Andrew Lynch, Dublin (IE); Torsten Krug, Berlin (DE)

Correspondence Address: SUGHRUE MION, PLLC, 2100 PENNSYLVANIA AVENUE, N.W., SUITE 800, WASHINGTON, DC, 20037, US

(73) Assignee: The Provost, Fellows and Scholars ofthe college of the Holy and Undivided Trinity of Queen Elizabeth, Dublin 2 (IE)

(21) Appl. No.: 11/910,060

(22) PCT Filed: Mar. 30, 2006
(86) PCT No.: PCT/IE2006/000021

§ 371 Date: Feb. 1, 2008

(30) Foreign Application Priority Data
Mar. 30, 2005 (IE) S2005/0174
Mar. 30, 2005 (IE) S2005/0175

(51) Int. Cl. G01J 11/00; G04F 13/02; G02F 1/35

(52) U.S. Cl. 250/201.1; 372/30

(57) ABSTRACT

Apparatus for determining the pulse width of ultra-short light pulses of an input repetitive light pulse signal comprises a two-photon absorption detector (2) in the form of a microcavity (3) having an active region (4) located between top and bottom distributed Bragg reflectors (5,6). An optical fibre cable 16 directs the input light pulse signal combined with a reference repetitive light pulse signal normal to an incident surface (8) of the detector (2). The input light pulse signal is split in a polarisation light splitter (19) to form the reference light pulse signal which is passed through a delay line (23) to a polarisation light combiner (20) to be combined with the input light pulse signal, and directed at the incident surface (8) by the optical fibre cable (16). The delay line (23) is operated for alternately bringing the respective light pulses of the input and reference light pulse signals into and out of phase with each other to produce a pulsed photocurrent in the microcavity (3). A monitoring circuit (14) monitors the pulsed photocurrent, and the pulse width of the light pulses is determined as the full width half maximum of the pulsed photocurrent trace. By varying the angle of incidence at which the input and reference light pulse signals are incident on the incident surface (8), the apparatus is tuneable to input light pulse signals of different wavelengths within a predetermined range of wavelengths.

The present invention relates to a method and apparatus for determining the pulse width of ultra-short light pulses of a repetitive light pulse signal, and in particular, for determining the pulse width of ultra-short light pulses of duration of the order of picoseconds (10⁻¹² seconds) and femtoseconds (10⁻¹⁵ seconds), for example, light pulses of duration in the range of 0.1 picosecond to 100 picoseconds at a repetition rate in the range of 10 GHz to 160 GHz. The invention also relates to a method and a photodetector device for detecting a light pulse of ultra-short duration of any one of a plurality of wavelengths within a predetermined range of wavelengths, and the invention further relates to a method and apparatus for determining the wavelength of a light pulse of ultra-short duration within a predetermined range of wavelengths.

In optical communications data is commonly transmitted by repetitive light pulse signals via optical fibre cables. In order to maximise the volume of data which can be transmitted through each optical fibre, data is transmitted in repetitive light pulse signals simultaneously of respective different wavelengths within a predetermined range of wavelengths, which typically is in the range of 1,250 nm to 1,610 nm. Additionally, in order to maximise the data transmission rate at which the data is transmitted, the repetition rate of the light pulses of the repetitive light pulse signals is in the range of 10 GHz to 160 GHz. This, thus, requires that the pulse width, in other words, the duration of each light pulse of the repetitive light pulse signals, should be in the femtosecond to picosecond ranges, and typically, the pulse width of repetitive light pulse signals in which data is transmitted is typically of 10 picoseconds or less. Received optical communications light pulse signals must be validated. One method for validating light pulse signals is to determine the pulse width of the light pulses of the light pulse signal, and provided the light pulses are within the nominal pulse width plus or minus a predetermined small margin of error, the light pulse signal is validated from the point of view of the pulse width of the light pulses. However, with pulse widths of the order of 10 picoseconds or less, and even 100 picoseconds or less, determining the length of such light pulses is particularly difficult due to the relatively short duration of the light pulses.

Additionally, as well as determining the pulse width of such light pulses of a repetitive light pulse signal, it may also be necessary to determine the wavelength of the light pulses of such a repetitive light pulse signal, and it may also be necessary to detect light pulses of such a repetitive light pulse signal within a predetermined range of wavelengths.

There is therefore a need for a method and apparatus for determining the pulse width of ultra-short light pulses of a repetitive light pulse signal, and there is also a need for a photodetector device and a method for detecting light pulses of ultra-short duration of wavelengths within a predetermined range of wavelengths, and there is a need for a method and apparatus for determining the wavelength of light pulses of ultra-short duration of wavelengths within a predetermined range of wavelengths.

The present invention is directed towards providing methods, apparatus and photodetector devices which address at least some of these problems.

According to the invention there is provided apparatus for determining the pulse width of light pulses of an input repetitive light pulse signal of repeating ultra-short light pulses, the apparatus comprising a two-photon absorption photodetector, the two-photon absorption photodetector being provided in the form of a microcavity comprising an active region and spaced apart first and second reflecting means between which the active region is located, and within which light resonates to produce a photocurrent as a result of the two-photon absorption effect, the active region and the first and second reflecting means being adapted so that the resonating lifetime of light in the microcavity is less than the pulse width of the light pulses, the pulse width of which is to be determined, a light directing means for directing the input repetitive light pulse signal into the microcavity for resonating therein, and for directing a reference repetitive light pulse signal of ultra-short repeating light pulses into the microcavity for resonating therein, and a means for progressively altering the phases relative to each other at which the light pulses of the respective input and reference light pulse signals enter the microcavity to produce a pulsed photocurrent from which the pulse width of the light pulses of the input light pulse signal is determined.

In one embodiment of the invention the active region and the first and second reflecting means are adapted so that the resonating lifetime of light in the microcavity is in the range of 0.1 to 0.9 times the pulse width of the light pulses the pulse width of which is to be determined. Preferably, the active region and the first and second reflecting means are adapted so that the resonating lifetime of light in the microcavity is in the range of 0.4 to 0.9 times the pulse width of the light pulses the pulse width of which is to be determined. Advantageously, the active region and the first and second reflecting means are adapted so that the resonating lifetime of light in the microcavity is approximately 0.9 times the pulse width of the light pulses the pulse width of which is to be determined.

In one embodiment of the invention the reflectivity of the second reflecting means is greater than the reflectivity of the first reflecting means.

In another embodiment of the invention the reflectivity of the first reflecting means is in the range of 0.05 to 0.99. Advantageously, the reflectivity of the first reflecting means is in the range of 0.6 to 0.99. Preferably, the reflectivity of the first reflecting means is approximately 0.95 for light pulses, the pulse width of which is to be determined of the order of one picosecond duration.

In another embodiment of the invention the reflectivity of the second reflecting means is in the range of 0.05 to 0.99. Preferably, the reflectivity of the second reflecting means is in the range of 0.8 to 0.99. Advantageously, the reflectivity of the second reflecting means is approximately 0.985.

In one embodiment of the invention the first and second reflecting means are provided as first and second distributed Bragg reflectors.

In another embodiment of the invention the first distributed Bragg reflector comprises in the range of 1 to 15 mirror pairs.

In a further embodiment of the invention each mirror pair of the first distributed Bragg reflector comprises a silicon/silicon dioxide mirror pair. Alternatively, each mirror pair of the first distributed Bragg reflector comprises a gallium arsenide/aluminium arsenide mirror pair.

In another embodiment of the invention the second distributed Bragg reflector comprises in the range of 1 to 25 mirror pairs.

In a further embodiment of the invention the second distributed Bragg reflector comprises approximately 15 mirror pairs.

In one embodiment of the invention each mirror pair of the second distributed Bragg reflector comprises a gallium arsenide/aluminium arsenide mirror pair. Alternatively, each mirror pair of the second distributed Bragg reflector comprises a silicon/silicon dioxide mirror pair.

In one embodiment of the invention the perpendicular length between the first and second reflecting means of the active region is adapted to be a function of the wavelength of the light pulses, the pulse width of which is to be determined.

In another embodiment of the invention the perpendicular length between the first and second reflecting means of the active region is a fractional function of the wavelength of the light pulses, the pulse width, of which is to be determined.

Preferably, the active region is of a material such that light of wavelength of the light pulses, the pulse width of which is to be determined resonates in the microcavity.

In one embodiment of the invention the active region is of a bulk semiconductor material. Alternatively, the active region comprises at least one quantum well layer.

In one embodiment of the invention the active region comprises a plurality of barrier layers with a quantum well layer disposed between adjacent barrier layers. Preferably, the material of each barrier layer is an alloy composition of aluminium and gallium arsenide. Advantageously, the material of each quantum well layer is an alloy composition of aluminium and gallium arsenide.

Ideally, the first reflecting means defines an incident surface, and the light directing means is adapted for directing at least the input light pulse signal into the microcavity through the incident surface.

In one embodiment of the invention the light directing means is adapted for directing the reference light pulse signal into the microcavity through the incident surface.

In another embodiment of the invention the reference light pulse signal is selected to be of wavelength similar to the wavelength of the input light pulse signal, and the light directing means is adapted for directing the input and reference light pulse signals at the incident surface at similar incident angles. Alternatively, the reference light pulse signal is selected to be of wavelength different to the wavelength of the input light pulse signal, and the light directing means is adapted for directing the reference light pulse signal at the incident surface at an angle of incidence different to the angle of incidence at which the input light pulse signal is directed at the incident surface.

Ideally, the light directing means is adapted for directing the input light pulse signal at the incident surface at an angle of incidence corresponding to the angle of incidence at which light of the wavelength of the input light pulse signal resonates in the microcavity, and preferably, the light directing means is adapted for directing the reference light pulse signal at the incident surface at an angle of incidence corresponding to the angle of incidence at which light of the wavelength of the reference light pulse signal resonates in the microcavity.

Preferably, one of the two-photon absorption detector and the light directing means is moveable relative to the other for varying the angle of incidence at which at least the input light pulse signal is directed at the incident surface for facilitating tuning of the apparatus for determining the pulse width of light pulses of input light pulse signals of wavelengths within a predetermined range of wavelengths.

In one embodiment of the invention the two-photon absorption photodetector is adapted so that light of the highest wavelength of the predetermined range of wavelengths resonates in the microcavity when incident normal to the incident surface.

In another embodiment of the invention the two-photon absorption photodetector is moveable relative to the light directing means. Alternatively, the light directing means is moveable relative to the two-photon absorption photodetector.

In one embodiment of the invention the light directing means comprises a first light directing means for directing the input light pulse signal at the incident surface, and preferably, the first light directing means is moveable relative to the two-photon absorption photodetector.

In another embodiment of the invention the light directing means comprises a second light directing means for directing the reference light pulse signal at the incident surface independent of the first light directing means, and in one embodiment of the invention the second light directing means is moveable relative to the two-photon absorption photodetector.

Preferably, a monitoring means is provided for monitoring the angle of incidence at which the input light pulse signal is incident on the incident surface, and is responsive to the pulsed photocurrent and the angle of incidence at which the input light pulse signal is directed at the incident surface for determining the wavelength of the input light pulse signal.

In one embodiment of the invention the means for progressively altering the phases relative to each other at which the light pulses of the respective input and reference light pulse signals enter the microcavity comprises a delay means, and one of the input and reference light pulse signals is passed through the delay means prior to being directed at the microcavity.

Preferably, the delay means is a variable delay means for progressively varying the delay to which the one of the input and reference light pulse signals are subjected. Advantageously, the delay means comprises a delay line. Advantageously, the delay line is a variable delay line.

In one embodiment of the invention the reference light pulse signal is passed through the delay means.

In another embodiment of the invention a polarisation light combiner is provided for combining the input and reference light pulse signals prior to being directed into the microcavity.

In a further embodiment of the invention the reference light pulse signal is derived from the input light pulse signal, and preferably, a polarisation light splitter is provided for splitting the reference light pulse signal from the input light pulse signal.

In one embodiment of the invention the reference light pulse signal is selected so that the pulse width of the light pulses thereof is similar to the pulse width of the light pulses of the input light pulse signal.

In another embodiment of the invention the reference light pulse signal is selected so that the repetition rate of the light pulses thereof is similar to the repetition rate of the light pulses of the input light pulse signal.

Alternatively, the reference light pulse signal is selected so that the pulse width of the light pulses thereof is different to the pulse width of the light pulses of the input light pulse signal.

Alternatively, the reference light pulse signal is selected so that the repetition rate of the light pulses thereof is a multiple value or a fraction value of the repetition rate of the light pulses of the input light pulse signal.

In one embodiment of the invention the apparatus is adapted for determining the pulse width of light pulses of pulse width not exceeding 500 picoseconds. Preferably, the apparatus is adapted for determining the pulse width of light pulses of pulse width not exceeding 100 picoseconds. Advantageously, the apparatus is adapted for determining the pulse width of light pulses of pulse width in the range of 10 femtoseconds to 100 picoseconds.

Preferably, a monitoring means is provided for monitoring the pulsed photocurrent and for determining the pulse width of the light pulses of the input light pulse signal from the monitored pulsed photocurrent. Preferably, the monitoring means is responsive to the full width half maximum of the peak value of the pulsed photocurrent for determining the pulse width of the light pulses of the input light pulse signal.

The invention also provides a method for determining the pulse width of light pulses of an input repetitive light pulse signal of repeating ultra-short light pulses, the method comprising providing a two-photon absorption detector in the form of a microcavity, whereby the microcavity comprises an active region and spaced apart first and second reflecting means between which the active region is located, and within which light resonates to produce a photocurrent as a result of the two-photon absorption effect, selecting the active region and the first and second reflecting means so that the resonating lifetime of light in the microcavity is less than the pulse width of the light pulses, the pulse width of which is to be determined, directing the input repetitive light pulse signal into the microcavity for resonating therein, directing a reference repetitive light pulse signal of ultra-short repeating light pulses into the microcavity for resonating therein, and progressively altering the phases relative to each other at which the light pulses of the respective input and reference light pulse signals enter the microcavity to produce a pulsed photocurrent from which the pulse width of the light pulses of the input light pulse signal is determined.

The invention also provides a photodetector device for detecting light of any one of a plurality of wavelengths within a predetermined range of wavelengths of an input light pulse of ultra-short duration, the photodetector device comprising a two-photon absorption detector comprising an active region within which incident light resonates to produce a detectable photocurrent as a result of the two-photon absorption effect, the two-photon absorption detector defining an incident surface for receiving incident light therethrough to the active region, and a light directing means for directing the input light pulse into the active region through the incident surface, one of the light directing means and the two-photon absorption detector being moveable relative to the other for varying the angle of incidence at which the input light pulse is incident on the incident surface for determining the wavelength of the input light pulse to which the photodetector device is responsive, so that when the light of the input light pulse contains light of the determined wavelength, the light of the input light pulse resonates in the active region to produce the detectable photocurrent.

In one embodiment of the invention the two-photon absorption detector is provided in the form of a microcavity comprising the active region located between spaced apart first and second reflecting means for reflecting light within the microcavity to resonate therein.

Preferably, the microcavity is adapted so that light of the longest wavelength of the predetermined range of wavelengths when incident normal to the incident surface resonates within the microcavity, and advantageously, the microcavity is adapted so that light of at least two wavelengths within the predetermined range of wavelengths when incident on the incident surface at similar incident angles resonates simultaneously within the microcavity.

In one embodiment of the invention the first and second reflecting means are adapted for determining the wavelengths of light which resonate within the microcavity.

Preferably, at least one of the first and second reflecting means comprises a distributed Bragg reflector comprising a plurality of spaced apart reflecting layers.

In one embodiment of the invention the second reflecting means comprises a distributed Bragg reflector comprising at least one mirror pair.

In another embodiment of the invention the first reflecting means comprises a distributed Bragg reflector comprising at least one mirror pair.

In one embodiment of the invention the spacing between the mirror pairs of the respective distributed Bragg reflectors of the first and second reflecting means is similar. Alternatively, the spacing between the mirror pairs of the respective distributed Bragg reflectors of the first and second reflecting means is different, so that light of two different wavelengths incident on the incident surface at similar incident angles resonates within the microcavity.

In one embodiment of the invention the spacing between the mirror pairs of the distributed Bragg reflector of the first reflecting means is less than the spacing between the mirror pairs of the distributed Bragg reflector of the second reflecting means.

In another embodiment of the invention the first reflecting means is of lower reflectivity than the reflectivity of the second reflecting means. Preferably, the reflectivity of the first reflecting means lies in the range of 0.05 to 0.99. Advantageously, the reflectivity of the first reflecting means is approximately 0.95.

Preferably, the reflectivity of the second reflecting means lies in the range of 0.05 to 0.99. Advantageously, the reflectivity of the second reflecting means is approximately 0.986.

In one embodiment of the invention the first reflecting means defines the incident surface.

In another embodiment of the invention the perpendicular length between the first and second reflecting means of the active region is adapted so that light of the greatest wavelength of the predetermined range of wavelengths when incident normal on the incident surface resonates within the microcavity.

In a further embodiment of the invention the perpendicular length between the first and second reflecting means of the active region is a function of the wavelength of light of the maximum wavelength of the predetermined range of wavelengths.

In a further embodiment of the invention the perpendicular length between the first and second reflecting means of the active region is a fraction function of the wavelength of light of the maximum wavelength of the predetermined range of wavelengths.

In one embodiment of the invention the perpendicular length between the first and second reflecting means of the active region is 458.9 nm, so that light of wavelength of 1,512 nm incident normal to the incident surface resonates in the microcavity.

Preferably, the material of the active region is such that light of the longest wavelength of the predetermined range of wavelengths when incident normal to the incident surface resonates in the active region.

In one embodiment of the invention the active region comprises an alloy composition comprising an alloy of aluminium, gallium and arsenide.

In another embodiment of the invention the active region comprises alternate active layers and barrier layers.

In a further embodiment of the invention each active layer of the active region comprises a quantum well.

In another embodiment of the invention each active layer of the active region comprises an alloy composition comprising an alloy of aluminium and gallium arsenide.

Preferably, each barrier layer of the active region comprises an alloy composition comprising an alloy of aluminium and gallium arsenide.

In another embodiment of the invention the active region is of a bulk semiconductor material.

In one embodiment of the invention the two-photon absorption detector is moveable relative to the light directing means. Alternatively, the light directing means is moveable relative to the two-photon absorption detector.

Preferably, a monitoring means is provided for monitoring the photocurrent produced by the two-photon absorption detector.

In one embodiment of the invention the photodetector device is adapted for detecting a light pulse of duration in the femtosecond and picosecond ranges. Preferably, the photodetector device is adapted for detecting a light pulse of duration up to 10 picoseconds.

Advantageously, the light directing means is adapted for directing a repetitive light pulse signal comprising a plurality of the light pulses at the incident surface.

In one embodiment of the invention the light pulses are of similar duration.

In another embodiment of the invention the photodetector device is adapted for detecting input light pulses of a repetitive input light pulse signal in which the light pulses are provided at a repetition rate in the range of 10 GHz to 160 GHz.

In a further embodiment of the invention the input light pulses of the repetitive input light pulse signal are provided with the input light pulses at a repetition rate of an optical communications signal.

The invention further provides apparatus for determining the wavelength of a light pulse of wavelength within a predetermined range of wavelengths, the apparatus comprising a photodetector device according to the invention for detecting light of any one of a plurality of wavelengths within the predetermined range of wavelengths, a means for moving one of the two-photon absorption detector and the light directing means until the detectable photocurrent is of maximum value, and a cross-reference means with wavelengths of light cross-referenced with corresponding angles of incidence of light on the incident surface for facilitating a determination of the wavelength of the light pulse.

Additionally the invention provides a method for detecting light of any one of a plurality of wavelengths within a predetermined range of wavelengths of an input light pulse of ultra-short duration, the method comprising providing a two-photon absorption photodetector having an active region within which light resonates to produce a detectable photocurrent as a result of the two-photon absorption effect, the two-photon absorption detector defining an incident surface for receiving incident light therethrough to the active region, and providing a light directing means for directing the input light pulse into the active region through the incident surface, and moving one of the light directing means and the two-photon absorption detector relative to the other for varying the angle of incidence at which the input light pulse is incident on the incident surface for determining the wavelength of the input light pulse to which the photodetector device is responsive, so that when the input light pulse contains light of the determined wavelength, the input light pulse resonates in the active region to produce the detectable photocurrent.

The invention also provides a method for determining the wavelength of a light pulse of wavelength within a predetermined range of wavelengths, the method comprising operating the photodetector device according to the invention for directing the light pulse at the incident surface, moving one of the two-photon absorption detector and the light directing means for varying the angle of incidence of the light pulse on the incident surface, detecting when the photocurrent is of maximum value as the angle of incidence of the light pulse on the incident surface is varied, and determining the wavelength of the light from the angle of incidence at which the photocurrent was of maximum value.

The advantages of the invention are many. The invention provides apparatus which is capable of determining the pulse width of ultra-short light pulses of a repetitive light pulse signal, and in particular, is capable of determining the pulse width of light pulses in the femtoseconds and picoseconds ranges. The apparatus according to the invention can determine the pulse width of such short duration pulses by virtue of the fact that the apparatus comprises a two-photon absorption detector which produces an enhanced photocurrent due to the two-photon absorption effect when light pulses of two light pulse signals are resonating in the microcavity of the two-photon absorption photodetector. By being capable of determining the pulse width of such ultra-short light pulses, the apparatus according to the invention is particularly suitable for use in optical communications, and in particular, for validating optical communications data signals. By virtue of the fact that the angle of incidence at which the input light pulse signal is directed at the incident surface is variable, the apparatus can also be adapted to determine the wavelength of light pulses within a predetermined range of wavelengths, and furthermore, the apparatus can be used as a tuneable apparatus for detecting a light pulse signal of a particular wavelength, while discriminating against light pulse signals of other wavelengths.

The photodetector device according to the invention is particularly suitable for detecting light pulses of ultra-short duration of wavelengths within a predetermined range of wavelengths, and is readily tuneable to specific wavelengths within the predetermined range of wavelengths. By virtue of the fact that the photodetector device according to the invention comprises a two-photon absorption detector, a detectable photocurrent is produced by the detector even where pulses of a repetitive light pulse signal are of duration of the order of femtoseconds. By providing the photodetector device with a two-photon absorption detector, once the repetitive input light pulse signal is directed at the appropriate incident angle at the incident surface to resonate in the microcavity of the two-photon absorption detector, the photocurrent produced by the two-photon absorption detector is sufficient to be detected.

Accordingly, by virtue of the fact that the apparatus and the photodetector device according to the invention are capable of detecting light pulses of a repetitive light pulse signal of light pulses of the order of femtosecond and picosecond duration, and furthermore, is capable of distinguishing such ultra-short pulses of light of different wavelengths within a predetermined range of wavelengths, which may be in the range of 1,478 nm to 1,512 nm, or any other desired range of wavelengths depending on the construction of the two-photon absorption detector, the apparatus and the photodetector device according to the invention are particularly suitable for use in high speed optical communication transmissions.

A further advantage of the invention is that light pulses of wavelengths other than the wavelength to which the apparatus or the photodetector device are tuned which are incident on the incident surface of the two-photon absorption detector, and which would thus not resonate in the microcavities of the respective apparatus and photodetector devices are reflected. Thus, in a communications system carrying light pulses of multiple wavelengths, the light pulses of the non-resonant wavelengths are reflected from the two-photon absorption detector, and can continue to carry data in the communications system.

The invention will be more clearly understood from the following description of some preferred embodiments thereof, which are given by way of example only, with reference to the accompanying drawings, in which:

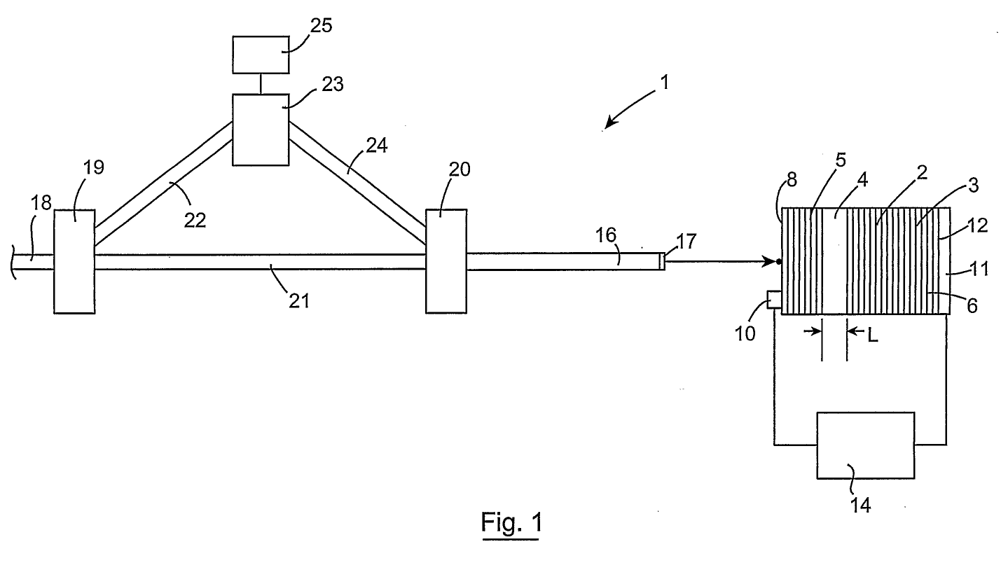

FIG. 1 is a schematic representation of apparatus according to the invention for determining the pulse width of pulses of a repetitive light pulse signal of ultra-short light pulses,

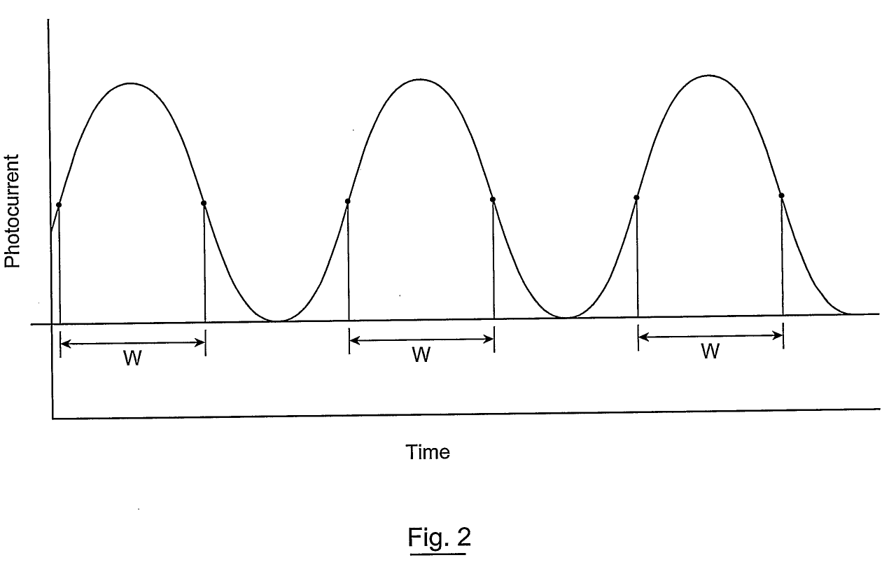

FIG. 2 is a trace of a waveform of a pulsed photocurrent generated by the apparatus of FIG. 1,

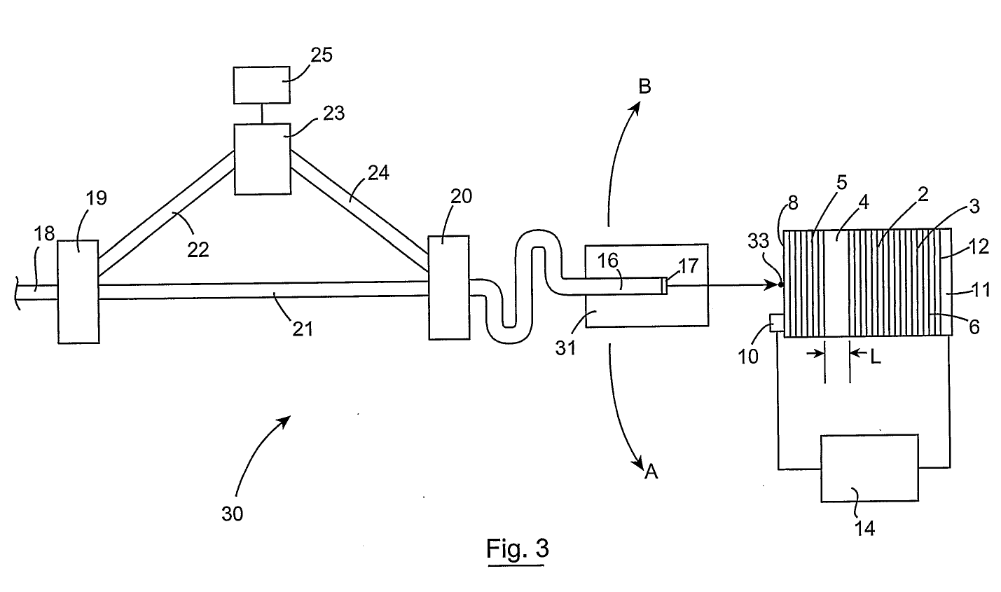

FIG. 3 is a view similar to FIG. 1 of apparatus according to another embodiment of the invention for determining the pulse width of pulses of a repetitive light pulse signal of ultra-short light pulses,

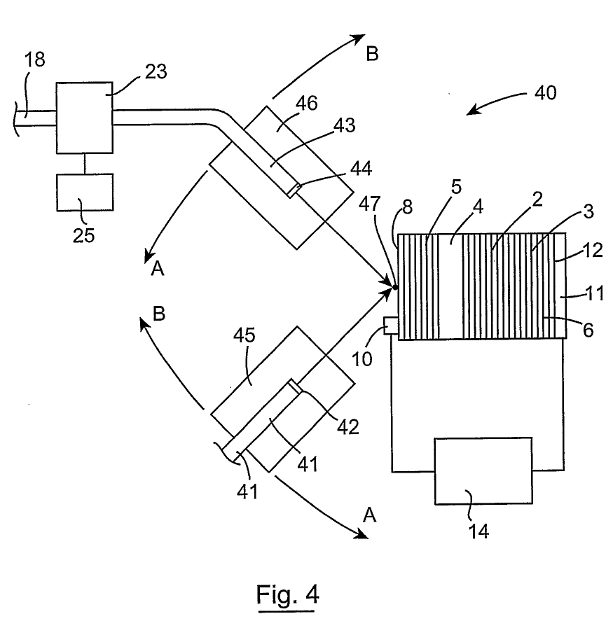

FIG. 4 is a view similar to FIG. 1 of apparatus according to a further embodiment of the invention for determining the pulse width of pulses of a repetitive light pulse signal of ultra-short light pulses,

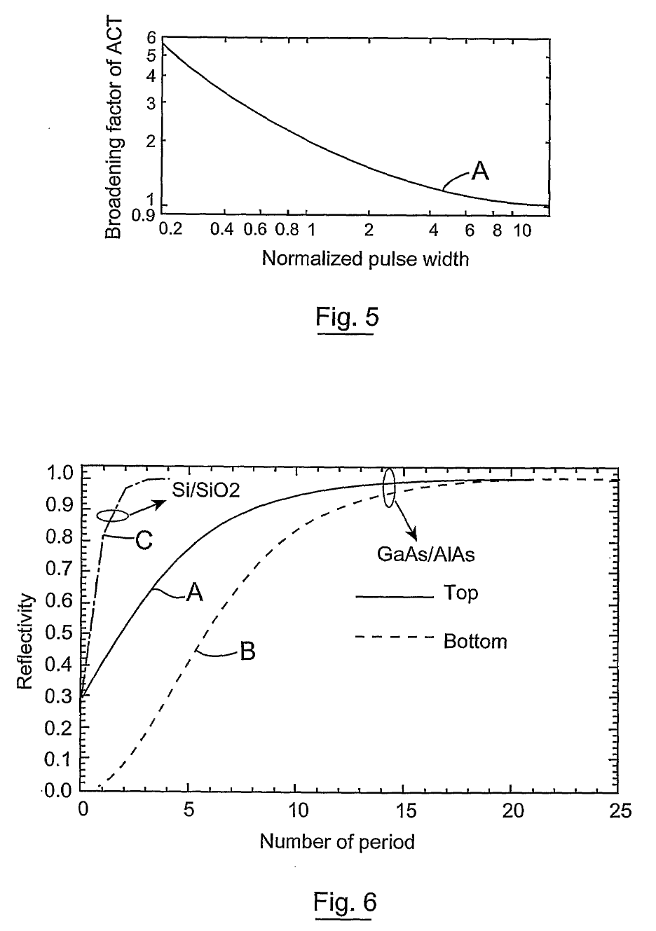

FIG. 5 illustrates the broadening factor of the auto-correlation trace plotted against normalised pulse width, resulting from the compute simulation of the apparatus of FIG. 1,

FIG. 6 illustrates the reflectivity plotted against the number of period for the GaAs/AlAs mirror and the Si/SiO₂ mirror of distributed Bragg reflectors of another computer simulation,

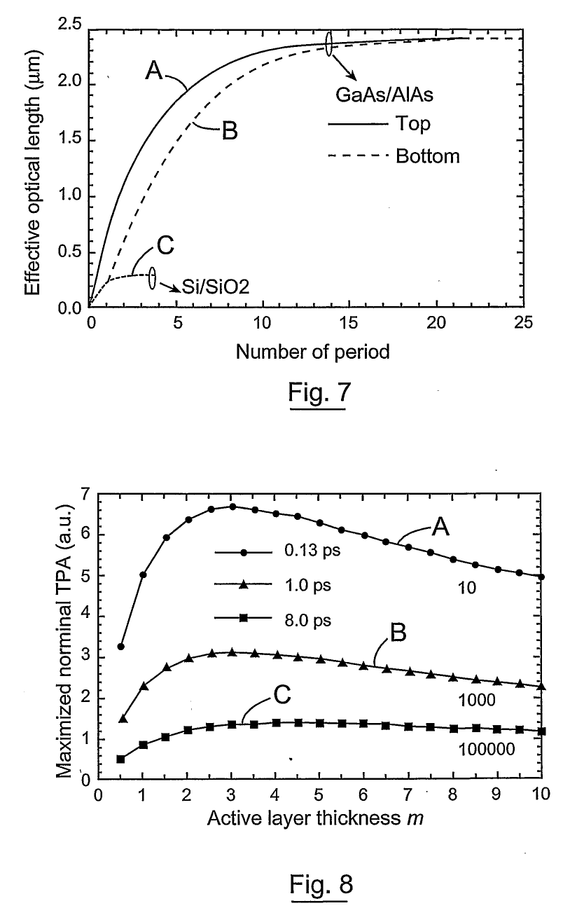

FIG. 7 illustrates the effective optical length of the Bragg mirrors contributed to the total optical length of the cavity from another computer simulation,

FIG. 8 illustrates the maximised nominal two-photon absorption plotted against the active layer thickness from another computer simulation, the hyperbolic secant incident pulse has a full width at the half maximum (FWHM) of 0.13, 1.0 and 8.0 ps, for the 0.13, 1.0 and 8.0 ps pulses the value in the figure should be multiplied by 10, 1,000 and 100,000, respectively,

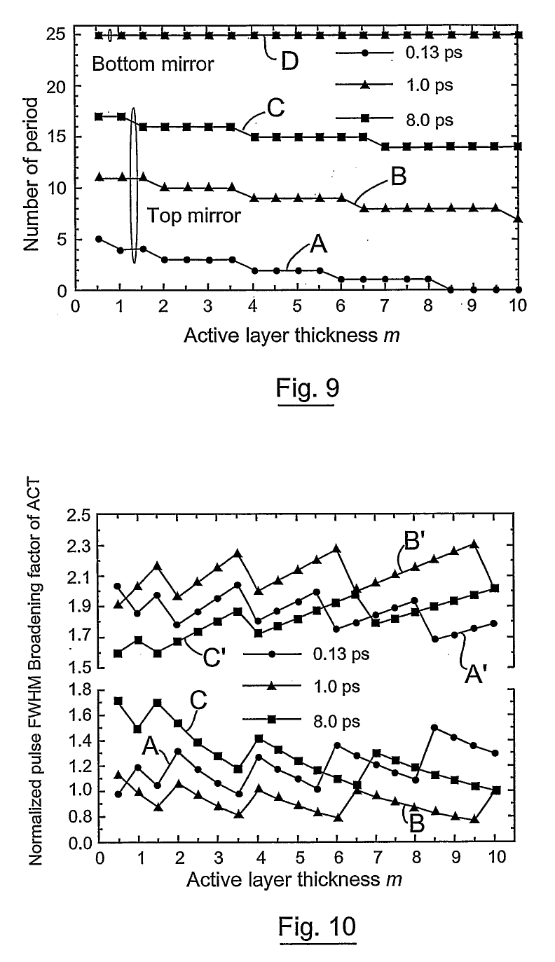

FIG. 9 illustrates the number of periods of the top and bottom Bragg mirrors for the maximum nominal two-photon absorption to be achieved from another computer simulation,

FIG. 10 illustrates the normalised pulse FWHM and broadening factor of the auto-correlation trace corresponding to the maximum nominal two-photon absorption to be achieved from another computer simulation,

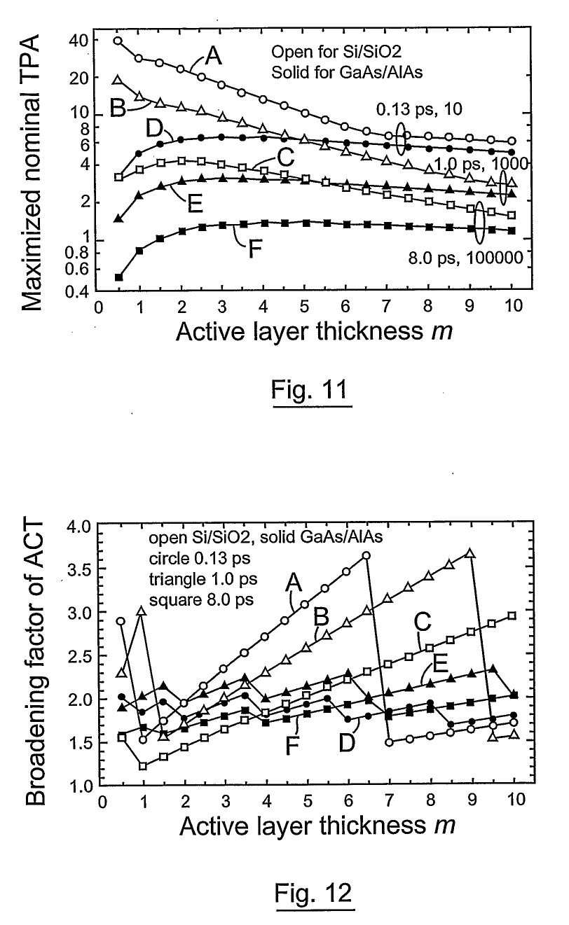

FIG. 11 illustrates the maximised nominal two-photon absorption achieved by the Si/SiO₂ mirror and the GaAs/AlAs mirror distributed Bragg reflectors from another computer simulation,

FIG. 12 illustrates the broadening factor of the auto-correlation trace for the Si/SiO₂ mirror and the GaAs/AlAs mirror of distributed Bragg reflectors from another computer simulation,

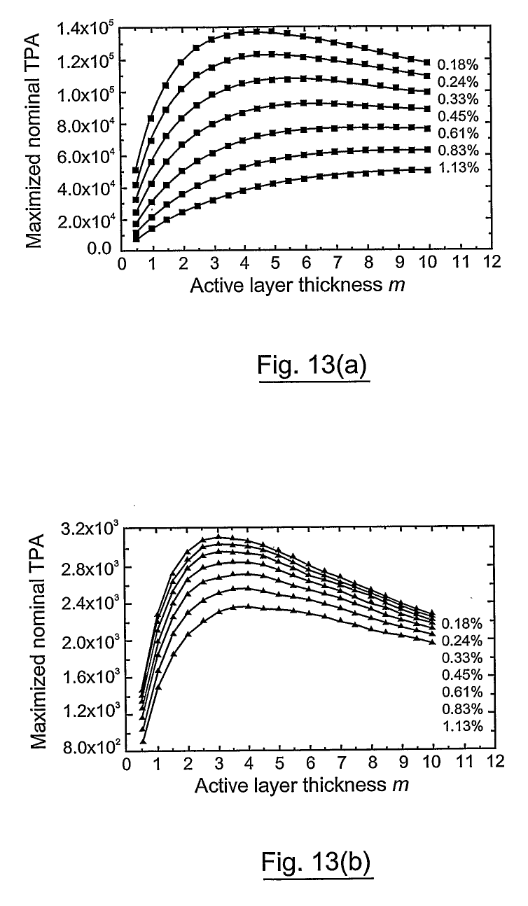

FIGS. 13 (a) and (b) illustrates the effect of the bottom mirror reflectivity on the maximised nominal two-photon absorption for a pulse width of 8.0 picoseconds and 1.0 picoseconds, respectively, from another computer simulation, the numbers indicated in the figures are (1−R_{b})×1100%,

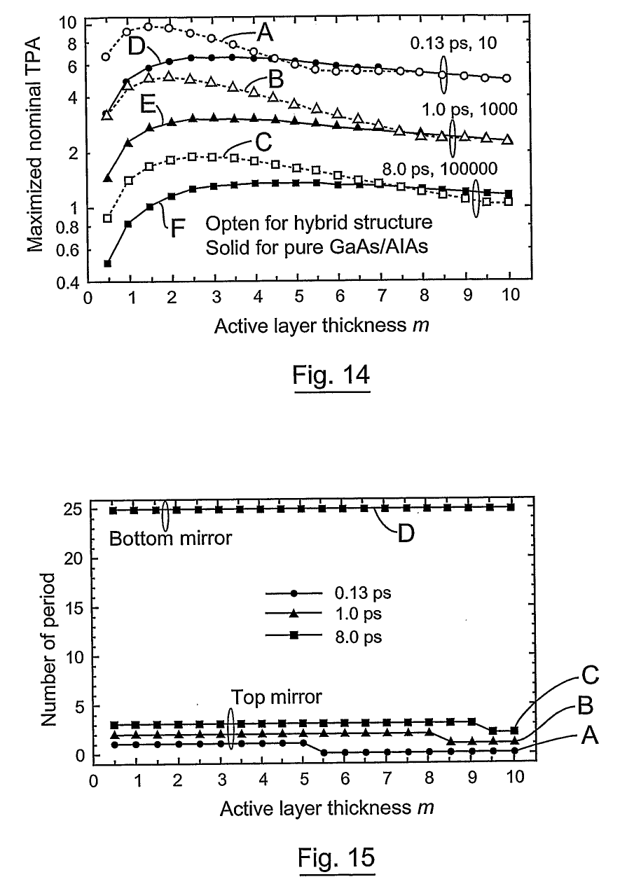

FIG. 14 illustrates the maximised nominal two-photon absorption achieved by a hybrid structure from another computer simulation of apparatus similar to that of FIG. 1 with top and bottom distributed Bragg reflectors of Si/SiO2 and GaAs/AlAs, respectively, pure GaAs/AlAs structure are also shown for comparison purposes,

FIG. 15 illustrates the number of periods of the top and bottom Bragg mirrors for the maximum nominal two-photon absorption to be achieved in the hybrid structure from another computer simulation,

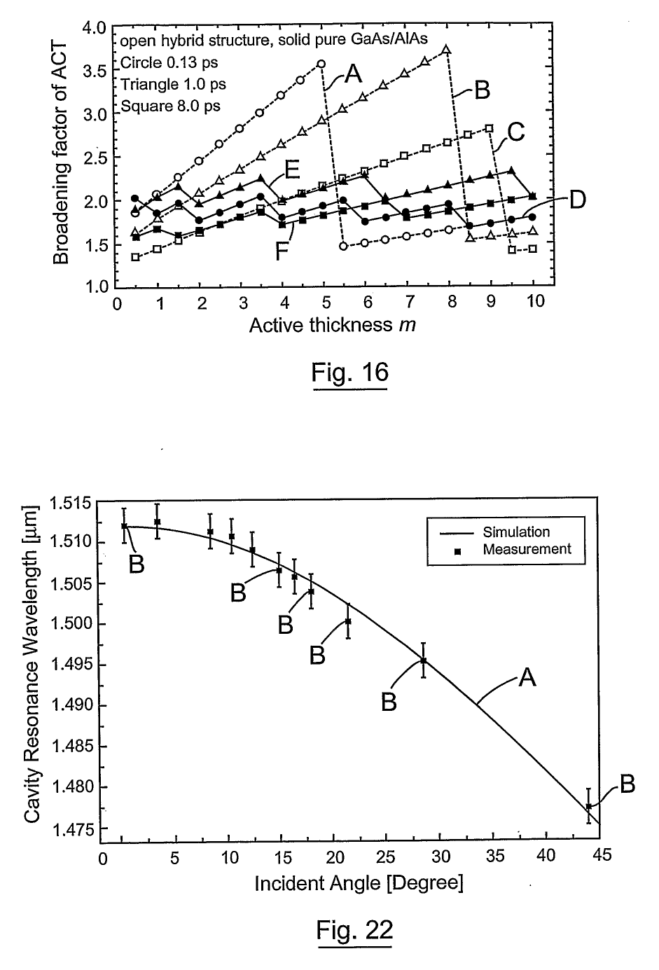

FIG. 16 illustrates the broadening factor of the auto-correlation trace for the hybrid structure and the pure GaAs/AlAs mirror structure from another computer simulation,

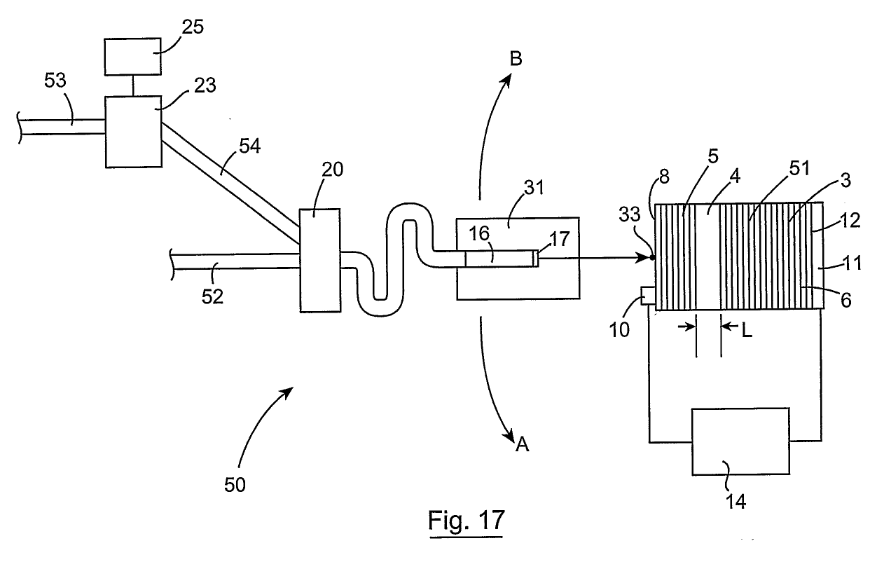

FIG. 17 is a view similar to FIG. 1 of apparatus according to another embodiment of the invention for determining the pulse width of pulses of a repetitive light pulse signal of ultra-short pulses,

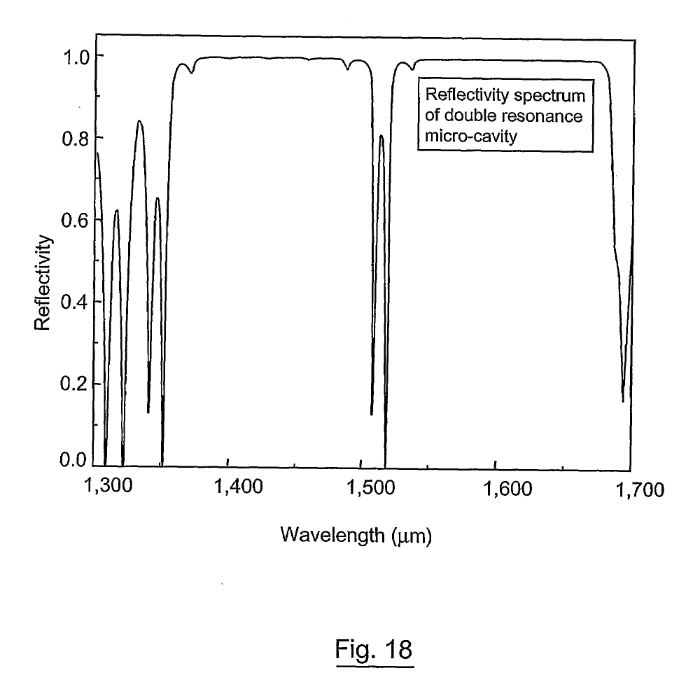

FIG. 18 illustrates the reflectivity spectrum of the microcavity of the two-photon absorption detector of the apparatus of FIG. 17,

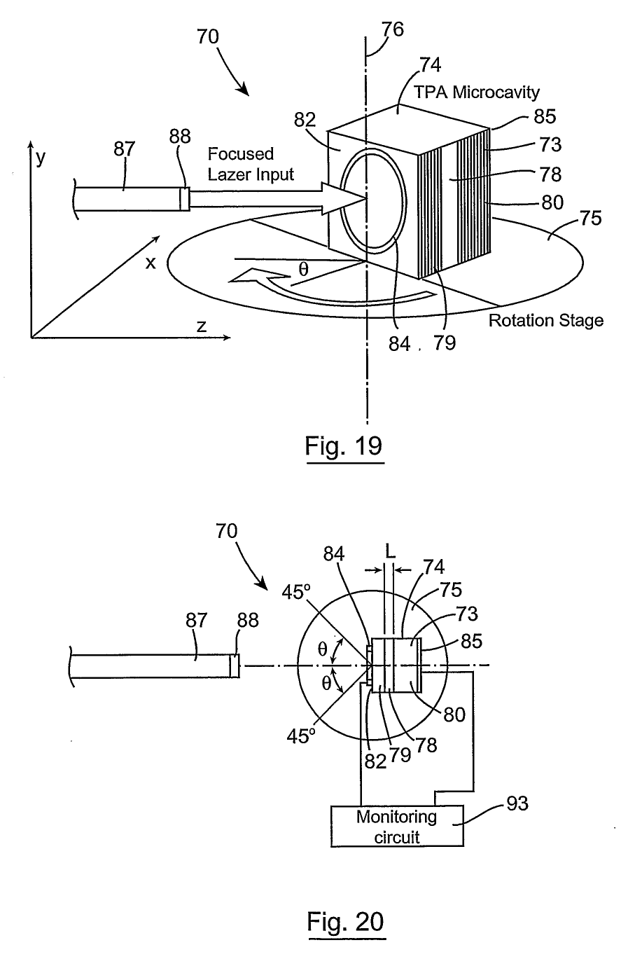

FIG. 19 is a schematic perspective view of a photodetector device according to the invention for detecting light of a plurality of selectable wavelengths within a predetermined range of wavelengths,

FIG. 20 is a schematic top plan view of the photodetector device of FIG. 19,

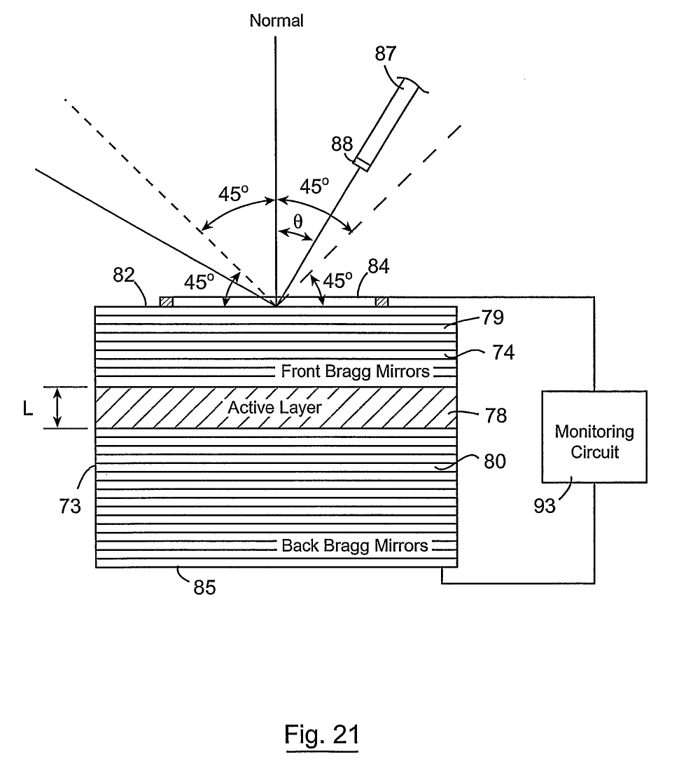

FIG. 21 is a transverse cross-sectional diagrammatic top plan view of a portion of the photodetector device of FIG. 19,

FIG. 22 illustrates comparative results from a computer simulation and experiments carried out on the photodetector device of FIG. 19 showing cavity resonance wavelength plotted against angle of incidence of an input light pulse signal, and

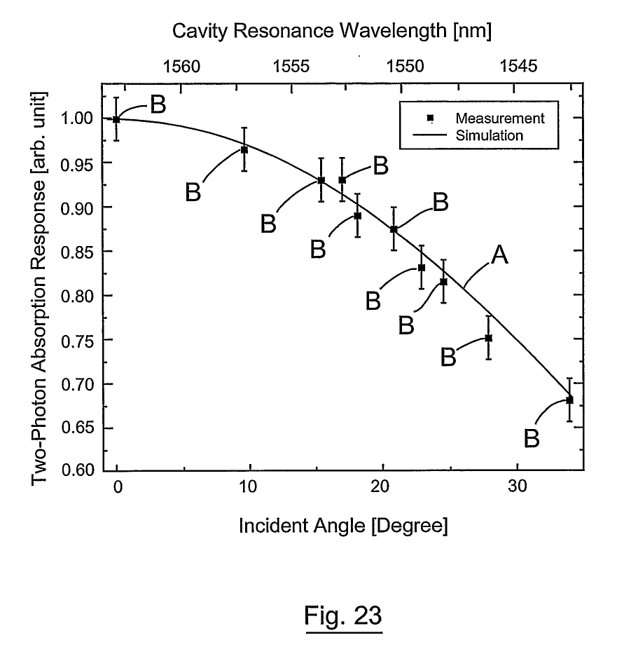

FIG. 23 illustrates the results of a computer simulation and experiments carried out on a photodetector device substantially similar to the photodetector device of FIG. 19 showing the relationship between the two-photon absorption response and incident angle of the input light pulse signal.

Referring to the drawings and initially to FIGS. 1 and 2, there is illustrated apparatus according to the invention, indicated generally by the reference numeral 1, for determining the pulse width of ultra-short light pulses of an input repetitive light pulse signal, and in particular, a repetitive light pulse signal in which the light pulses are of pulse width in the range of 0.1 picosecond to 100 picoseconds at a repetition rate in the range of 10 GHz to 160 GHz. Repetitive light pulse signals of duration in the range of 0.1 picosecond to 100 picoseconds at a repetition rate of 10 GHz to 160 GHz are typical of those used in optical communications. However, in this particular embodiment of the invention the apparatus is suitable for determining the pulse width of light pulses of duration of the order of 1 picosecond at a repetition rate up to 160 GHz and of wavelength of the order of 1,550 nm.

The apparatus 1 comprises a planar two-photon absorption photodetector 2 in the form of a microcavity 3, which comprises an active region 4 located between spaced apart first and second reflecting means, namely, a top distributed Bragg reflector 5 and a bottom distributed Bragg reflector 6, respectively. The top distributed Bragg reflector 5 defines a planar incident surface 8 through which the input repetitive light pulse signal and a reference repetitive light pulse signal are directed into the active region 4 for resonating therein, as will be described below. The active region 4 and the top and bottom Bragg reflectors 5 and 6 are selected as will be described below so that when light of light pulses of two light pulse signals of the desired wavelength is incident normal on the incident surface 8 and the light pulses of the respective light pulse signals are in phase or at least are overlapping with each other, the light of the overlapping light pulses resonates in the microcavity 3 to produce a detectable photocurrent as a result of the two-photon absorption effect. Accordingly, as will be described below, by alternately bringing the light pulses of the input light pulse signals into and out of phase with ultra-short light pulses of a reference repetitive light pulse signal, a pulsed photocurrent is generated, the trace of which is similar to the waveform illustrated in FIG. 2, and from which the pulse width of the light pulses of the input light pulse signal can be determined, as will also be described below.

A pair of electrodes 10 and 11 formed on the incident surface 4 of the top distributed Bragg reflector 5 and on an underneath surface 12 of the bottom distributed Bragg reflector 6, respectively, are provided for facilitating detection of the pulsed photocurrent. A monitoring circuit 14, which is coupled to the electrodes 10 and 11, monitors the pulsed photocurrent for determining the width of the light pulses of the input light pulse signal. Additionally, the active region 4 and the top and bottom distributed Bragg reflectors 5 and 6 are adapted so that the resonance lifetime of light in the microcavity 3 is less than the pulse width of the light pulses of the input light pulse signal.

A light directing means for directing both the input and reference light pulse signals at the incident surface 8 comprises an optical fibre cable 16 and a lens 17 which direct the input and reference light pulse signals at the incident surface 8 at an angle of incidence, which in this embodiment of the invention is normal to the incident surface 8. In this embodiment of the invention the reference light pulse signal is derived from the input light pulse signal, and the input light pulse signal is applied to an input optical fibre cable 18. A polarisation light pulse splitter 19 splits the input light pulse signal into two signals, namely, the input light pulse signal which is applied to a polarisation light combiner 20 through a first intermediate optical fibre cable 21, and the reference light pulse signal. A second intermediate optical fibre cable 22 applies the reference light pulse signal to a means for progressively altering the phase of the light pulses of the reference light pulse signal relative to the light pulses of the input light pulse signal, which in this embodiment of the invention is provided by a variable delay line 23. A third intermediate optical fibre cable 24 applies the reference input light pulse signal from the delay line 23 to the polarisation light combiner 20 where the reference light pulse signal is combined with the input light pulse signal, and the auto-correlated input and reference light pulse signals are directed at the incident surface 8 by the optical fibre cable 16 and the lens 17.

A mechanism 25, which is illustrated in block representation in FIG. 1, is provided for operating the delay line 23 for progressively increasing or decreasing the delay to which the reference light pulse signal is subjected in the delay line 23 for progressively altering the phase at which the pulses of the reference light pulse signal enter the microcavity 3 through the incident surface 8 relative to the phase at which the light pulses of the input light pulse signal enter the microcavity 3 through the incident surface 8. Such control mechanisms 25 for operating a delay line 23 will be well known to those skilled in the art.

By progressively varying the delay to which the reference light pulse signal is subjected relative to the input light pulse signal, the pulses of the respective input and reference light pulse signals are alternately brought into and out of phase with each other. While the light pulses of the respective input and reference light pulse signals are in phase or overlapping with each other, and are resonating in the microcavity 3, a photocurrent is produced which is detected by the monitoring circuit 14, and when the light pulses of the input and reference light pulse signals are not overlapping with each other, no photocurrent is produced. Thus, as the pulses of the respective input and reference light pulse signals are alternately brought into and out of phase with each other, the pulsed photocurrent, a trace of which is illustrated in FIG. 2, is produced in the microcavity which is detected by the monitoring circuit 14.

The monitoring circuit 14 determines the full width half maximum of the peak value, namely, the width W of the pulses of the trace of the pulsed photocurrent, see FIG. 2, which is equal to the pulse width of the light pulses of the input light pulse signal.

Since the apparatus 1 is to determine the length of light pulses of the input light pulse signal which is directed normal to the incident surface 8, and which in this embodiment of the invention is 1,550 nm, the active region 4 comprises a bulk semiconductor material of gallium arsenide, and the length L of the active region 4 in a direction between and perpendicular to the top and bottom distributed Bragg reflectors 5 and 6 is 0.459 μm, which is a fractional function of the wavelength of the light of 1,550 nm. The top distributed Bragg reflector 5 of the two-photon absorption detector 2 has a reflectivity of approximately 0.99895, and comprises four mirror pairs of silicon/silicon dioxide. The bottom distributed Bragg reflector 6 has a reflectivity of approximately 0.9982 and comprises twenty mirror pairs of gallium arsenide/aluminium arsenide. Thus, with the two-photon absorption photodetector 2 constructed with the active region 4 and top and bottom distributed Bragg reflectors 5 and 6, respectively, as described light incident on the incident surface 8 of wavelength of 1,550 nm resonates in the microcavity 3, and thus, when, the light pulses of the input and reference light pulse signals are incident normal on the incident surface 8 and overlap in the microcavity 3, the light of the respective overlapping light pulses simultaneously resonates in the microcavity 3 to produce the pulsed photocurrent.

Additionally, by providing the top distributed Bragg reflector with four mirror pairs of silicon/silicon dioxide, and the bottom distributed Bragg reflector 6 with twenty mirror pairs of gallium arsenide/aluminium arsenide, the resonance lifetime of light of 1,550 nm in the microcavity 3 is less than the pulse width, in other words, is less than the duration of the light pulses of the input light pulse signal.

In use, the input light pulse signal is applied to the input optical fibre cable 18, and the input light pulse signal is split in the polarisation light splitter 19 to produce the reference light pulse signal, which is passed through the variable delay line 23. The reference and input light pulse signals are combined in the polarisation light combiner 20 and directed normal to the incident surface 8. The mechanism 25 is operated for operating the delay line 23 for progressively increasing the delay to which the reference light pulse signal is subjected relative to the input light pulse signal for in turn progressively altering the phase of the light pulses of the reference light pulse signal relative to the phase of the light pulses of the input light pulse signal for in turn alternately bringing the light pulses of the reference light pulse signal into and out of phase with the light pulses of the input light pulse signal. When the wavelength of the input light pulse signal is 1,550 nm and the light pulses of the input and reference light pulse signals are alternately brought into and out of phase with each other, the pulsed photocurrent is generated in the microcavity 3, which is detected by the monitoring circuit 14. The monitoring circuit 14 reads the trace of the pulsed photocurrent and determines the full width half maximum W of the peak value of the pulses traced by the pulsed photocurrent, and determines the pulse width of the pulses of the input light pulse signal as being equal to the full width half maximum W of the peak value of the waveform traced by the photocurrent.

Referring now to FIG. 3, there is illustrated a tuneable apparatus also according to the invention, indicated generally by the reference numeral 30, for determining the pulse width of an input repetitive light pulse signal of ultra-short pulses of any of a plurality of wavelengths within a predetermined range of wavelengths, which in this embodiment of the invention ranges from 1,515 nm to 1,550 nm. The apparatus 30 is substantially similar to the apparatus 1 and similar components are identified by the same reference numerals. The main difference between the apparatus 30 and the apparatus 1 is that the optical fibre cable 16 and the lens 17 are mounted on a platform 31 which is swivelable in the direction of the arrows A and B about a central pivot axis 33 which is contained in a plane defined by the incident surface 8 of the two-photon absorption detector 2, and extends perpendicularly into the page. The platform 31 is swivelable from a central position illustrated in FIG. 3 with the optical fibre cable 16 and the lens 17 extending perpendicularly relative to the incident surface 8 for directing the combined input and reference light pulse signals normal to the incident surface 8, to respective extreme positions (not shown) in the directions of the arrows A and B on opposite sides of the central position with the optical fibre cable 16 and the lens 17 extending at +45° or −45° relative to the normal to the incident surface 8 for directing the combined input and reference light pulse signals at the incident surface 8 at incident angles of +45° and −45°, respectively.

By swivelling the platform 31 and the optical fibre cable 16 and the lens 17 about the pivot axis 33, the angle of incidence at which the input and reference light pulse signals are incident on the incident surface 8 is varied, and thus the wavelength of light to which the microcavity 3 is responsive may be varied within the predetermined range of wavelengths. The wavelength of light which resonates in the microcavity 3 when the light is incident normal to the incident surface 8 is the maximum wavelength of the predetermined range of wavelengths, namely, 1,550 nm, and the wavelength of light which resonates in the microcavity 3 decreases as the angle of incidence of the light on the incident surface 8 increases in the directions of the arrows A and B of FIG. 3 from normal, until the platform 31 is in either of its extreme +45° or −45° from the central position, at which stage light of the minimum wavelength of the predetermined range of wavelengths, namely, 1,515 nm resonates in the microcavity 3. The decrease in the wavelength of light which resonates in the microcavity 3 as the angle of incidence of the light on the incident surface 8 increases from normal is similar irrespective of whether the angle of incidence is increased in the positive or negative direction from normal.

In this embodiment of the invention, the two-photon absorption photodetector 2 of the apparatus 30 is similar to the two-photon absorption photodetector 2 of the apparatus 1, and the microcavity 3 of the apparatus 30 is suitable for determining the pulse width of light pulses of an input repetitive light pulse signal of wavelength of 1,550 nm when the platform 31 is set in the central position with the combined input and reference light pulse signals directed normal to the incident surface 8, and is suitable for determining the pulse width of light pulses of input light pulse signals of decreasing wavelength down to 1,515 nm when the platform 31 has been swivelled from the central position into either of the two extreme positions with the combined input and reference light pulse signals directed at the incident surface 8 at an angle of incidence of +45° or −45° from normal. Accordingly, the apparatus 30 is particularly suitable for determining the pulse width of light pulses of a repetitive light pulse signal where the wavelength of the light may be any wavelength within the predetermined range of wavelengths of 1,515 nm to 1,550 nm. The platform 31 is set at the appropriate angle relative to the central position, so that the optical fibre cable 16 and the lens 17 direct the combined input and reference light pulse signal at the incident surface 8 at an angle of incidence corresponding to the angle of incidence at which light of the wavelength of the light pulses, the pulse width of which is to be determined, resonates in the microcavity 3. Thus, the apparatus 30 is a tuneable apparatus which is tuneable to any wavelength within the predetermined range of wavelengths for determining the pulse width of light pulses of an input repetitive light pulse signal of any desired wavelength within the predetermined range of wavelengths.

In use, the platform 31 is set relative to the two-photon absorption detector 2 so that the optical fibre cable 16 and the lens 17 direct the combined input and reference light pulse signals at the incident surface 8 at the appropriate angle of incidence corresponding to the wavelength of the light pulses of the input light pulse signal he pulse width of which is to be determined. Once the input light pulse signal is of the wavelength to which the apparatus 1 is tuned, the apparatus 30 operates in similar fashion to that of the apparatus 1 for determining the pulse width of the light pulses of the repetitive light pulse signal.

It will be appreciated that instead of mounting the optical fibre cable 16 and the lens 17 on the platform 31 of the apparatus 1, and mounting the platform 31 to be swivelable relative to the two-photon absorption detector 2, the optical fibre cable 16 and the lens 17 may be mounted in a fixed position, and the two-photon absorption detector 2 may be mounted on a platform which would be rotatable about a central pivot axis similar to the central pivot axis 33 which would be contained in a plane defined by the incident surface 8 of the two-photon absorption detector 2. Thus, by pivoting the platform about the central pivot axis, the angle of incidence at which the combined input and reference light pulse signal would be directed by the optical fibre cable 16 and the lens 17 at the incident surface 8 would be variable for tuning the apparatus for determining the pulse width of light pulses of an input light pulse signal of any wavelength within the predetermined range of wavelengths.

Referring now to FIG. 4, there is illustrated tuneable apparatus according to another embodiment of the invention, indicated generally by the reference numeral 40, for determining the pulse width of light pulses of an input repetitive pulse light signal of repeating ultra-short light pulses of any of a plurality of wavelengths within a predetermined range of wavelengths, which in this embodiment of the invention is in the range of 1,515 nm to 1,550 nm, and is similar to the range of wavelengths to which the apparatus 30 of FIG. 3 is tuneable. The apparatus 40 is substantially similar to the apparatus 1, and similar components are identified by the same reference numerals. The main difference between the apparatus 40 and the apparatus 1 is that in this embodiment of the invention the reference repetitive light pulse signal is derived from a source different to the source of the input repetitive light pulse signal, and the light directing means comprises a first light directing means, namely, a first optical fibre cable 41 and a first lens 42 for directing the input light pulse signal at the incident surface 8, and a second optical fibre cable 43 and a second lens 44 for directing the reference light pulse signal at the incident surface 8. The first optical fibre cable 41 and the first lens 42 are mounted on a first platform 45, and the second optical fibre cable 43 and the second lens 44 are mounted on a second platform 46, both of which are swivelable independently of each other in the directions of the arrows A and B about a central pivot axis 47, which is similar to the pivot axis 33 of the apparatus 30, and lies in a plane defined by the incident surface 8.

By providing the first and second platforms 45 and 46 pivotal relative to each other, the apparatus 40 is responsive to input and reference light pulse signals of respective different wavelengths within the predetermined range of wavelengths. By appropriately setting the first and second platforms 45 and 46 relative to the incident surface 8, the wavelengths of the input and reference light pulse signals which resonate in the microcavity 3 can be selected, and may be of the same or different wavelengths. The pulse width and the repetition rate of the light pulses of the reference light pulse signal ideally should be similar or substantially similar to the pulse width and repetition rate of the light pulses of the input light pulse signal, although this is not essential, however, the pulse width of the light pulses of the reference light pulse signal should be within the ultra-short range, and the repetition rate of the light pulses of the reference light pulse signal could be a multiple or a fraction of the repetition rate of the light pulses of the input light pulse signal.

In this embodiment of the invention the input light pulse signal is applied directly to the first optical fibre cable 41, and the reference light pulse signal is applied to the input optical fibre cable 18, and is in turn passed through the variable delay line 23 prior to being applied to the second optical fibre cable 43. However, if desired, the input light pulse signal could be applied to the input optical fibre cable 18, and the reference light pulse signal could be applied to the first optical fibre cable 41, in which case, the delay would be applied to the input light pulse signal instead of the reference light pulse signal.

It is also envisaged that in certain cases, the second platform 46 of the apparatus 40 described with reference to FIG. 4 may be fixed relative to the two-photon absorption detector 2, and in which case, the reference light pulse signal would be derived from a reference source of fixed wavelength, which would correspond with the angle of incidence at which the second optical fibre cable 43 and the second lens 44 direct the reference light pulse signal at the incident surface 8, which typically would be normal. It is also envisaged that the reference light pulse signal may be derived from a source which would facilitate altering the pulse width and the repetition rate of the light pulses of the light pulses of the reference light pulse signal.

In use, the input light pulse signal is applied to the first optical fibre cable 41, and the reference light pulse signal is applied to the input optical fibre cable 18. If the second platform 46 is swivelable relative to the two-photon absorption detector 2, the second platform 46 is swivelled until the angle of incidence at which the reference light pulse signal is directed to the incident surface 8 by the second optical fibre cable 43 and the second lens 44 is at the angle of incidence which corresponds to the angle of incidence at which light of the wavelength of the reference light pulse signal resonates in the microcavity 3. Otherwise the reference light pulse signal is selected to be of wavelength which resonates in the microcavity 3 at the angle of incidence at which the reference light pulse signal is directed at the incident surface 8 by the second optical fibre cable 43. If the apparatus 40 is to be responsive to an input light pulse signal of a specific wavelength within the predetermined range of wavelengths, the first platform 45 is swivelled relative to the two-photon absorption detector 2 until the apparatus 1 is tuned to receive light of the specific wavelength, in other words, until the first optical fibre cable 41 and the first lens 42 are angled relative to the incident surface 8 for directing the input light pulse signal at the incident surface 8 at an angle of incidence corresponding to the angle of incidence at which light of the specific wavelength resonates in the microcavity 3. The delay line 23 is operated in similar fashion as in the apparatus 1 and 30 described with reference to FIGS. 1 to 3 for progressively varying the delay to which the reference light pulse signal is subjected relative to the input light pulse signal, and when the wavelength of the input light pulse signal is of the specific wavelength, the pulsed photocurrent is detected by the monitoring circuit 14, and the pulse width of the input light pulse signal is determined by the monitoring circuit 14 as already described with reference to the apparatus 1 and 30 of FIGS. 1 to 3. Accordingly, as well as determining the pulse width of the light pulses of the input light pulse signal, the apparatus 40 of FIG. 4 is also suitable for detecting an input light pulse signal of a predetermined wavelength within the predetermined range of wavelengths, by merely tuning the apparatus 40 to the particular wavelength of the light of the input light pulse signal which is to be detected.

Additionally, the apparatus 40 according to the invention may be operated for determining the wavelength of an input light pulse signal within the predetermined range of wavelengths from 1,515 nm to 1,550 nm, as well as determining the pulse width of the light pulses of the input light pulse signal. In which case, with the reference light pulse signal applied to the input optical fibre cable 18 and directed at the incident surface 8 to resonate within the microcavity 3, the input light pulse signal is applied to the first optical fibre cable 41, and the first platform 45 is swivelled about the central pivot axis 47 relative to the two-photon absorption detector 2 for tuning the apparatus 40 until the pulsed photocurrent produced by the light pulses of the input and reference light pulse signals simultaneously resonating in the microcavity 3 are detected by the monitoring circuit 14 and are of maximum value. At which stage, the incident angle at which the input light pulse signal is directed at the incident surface 8 by the first optical fibre cable 41 and the lens 42 is determined, and the wavelength of the light of the input light pulse signal can then be read from a look-up table with angle of incidence cross-referenced with wavelengths. The monitoring circuit 14 can then determine the pulse width of the light pulses of the input light pulse signal as already described.

While the input light pulse signal is being directed at the incident surface 8, and the first platform 45 is being swivelled about the central pivot axis 47 for tuning the apparatus 40 to receive the input light pulse signal, the delay line 23 is operated as already described for progressively increasing or decreasing the delay to which the reference light pulse signal is subjected in order to bring the pulses of the reference and input light pulse signals alternatively into and out of phase with each other.

Where the apparatus 40 is to be operated for determining the wavelength of an input light pulse signal, it is envisaged that the platform 45 would be swivelled about the central pivot axis 47 by a suitable drive means, for example, a stepper motor or a servomotor, and a suitable means for detecting the angle through which the first platform 45 is swivelled from normal would also be provided, and such an angle detecting means may be a rotary potentiometer or the like. Additionally, the monitoring circuit 14 would be provided with a suitable memory in which a look-up table would be stored with wavelengths of light cross-referenced with the corresponding angle of incidence. The monitoring circuit 14 would be programmed to operate the drive means to swivel the first platform 45 until a pulsed photocurrent was detected representative of the light pulses of the reference and input light pulse signals simultaneously resonating in the microcavity 3. At which stage, the monitoring circuit 14 would be programmed to read the angle to which the first platform 45 had been swivelled from the central normal position from the angle detecting means for determining the angle of incidence at which the input light pulse signal was directed by the first optical fibre cable 41 and the first lens 42 to produce the detected pulsed photocurrent, and on reading the angle, the monitoring circuit 14 would be programmed to read the wavelength of light corresponding to the angle of incidence from the look-up table. Thus, the monitoring circuit 14 would indicate the wavelength of the light of the input light pulse signal and the pulse width of the light pulses thereof. Typically, this data would be displayed on a suitable visual display screen.

Similarly, the apparatus 30 described with reference to FIG. 3 may be used for determining the wavelength of an input light pulse signal within the predetermined range of wavelengths to which the apparatus 30 can be tuned. Operation of the apparatus 30 for determining the wavelength of an input light pulse signal would be similar to that described with reference to the apparatus 40 of FIG. 4. In the case of the apparatus 30 the input light pulse signal would be applied to the optical fibre cable 18, and while the delay line 23 is being operated, the platform 31 would be swivelled for tuning the apparatus 30 to the wavelength of the input light pulse signal.

A computer simulation has been made of a two-photon absorption detector similar to the two-photon absorption detector 2 of the apparatus 1, and waveforms of FIGS. 5 to 16 have been derived from the computer simulation. However, in the simulation the active region 4 was of bulk semiconductor material, namely, gallium arsenide, and the cavity length L was 458.9 nm. The top and bottom distributed Bragg reflectors were both gallium arsenide/aluminium arsenide λ/4 stacks. The two-photon absorption photodetector of the computer simulation was suitable for determining the pulse width of an auto-correlated input light pulse signal incident normal on the incident surface of the two-photon absorption photodetector of wavelength 1,550 nm.

The correlation trace is always symmetric independent of whether the pulse is symmetric or not, however the broadening of the pulse causes the correlation trace to be broadened. The curve A of FIG. 5 is a plot of the broadening factor of the auto-correlation trace against normalised pulse width. In FIG. 5 the broadening factor of the auto-correlation trace is plotted on the Y-axis, and normalised pulse width is plotted on the X-axis. From the curve A of FIG. 5 it can be seen that for a pulse width of 2.0 and the pulse carrier frequency coinciding with the cavity mode frequency, the broadening factor is 1.5, that is, 500% broader than if the incident pulse is directly auto-correlated.

In practical designing of a microcavity two-photon absorption detector, the permitted pulse broadening or the correlation trace broadening limits the cavity lifetime which can be selected for a given incident pulse. However, for a specific cavity lifetime the reflectivity distribution between the top and bottom distributed Bragg reflectors and the microcavity length L can be optimised to maximise the two-photon absorption inside the microcavity, while minimising the cavity lifetime.

The following is an outline of how a planar microcavity structure of a two-photon absorption detector can be designed for maximising two-photon absorption while minimising the cavity lifetime. There are three parameters to be determined: the number of mirror pairs of the top distributed Bragg reflector, namely, Nₜ, the number of mirror pairs of the bottom distributed Bragg reflector, namely, N_{b}, the active layer length L=m×0.459 μm, where m is half integer, and the active material of the active region, which is assumed to be GaAs, and the incident wavelength is assumed to be 1,550 nm. The refractive index of GaAs is 3.377 at the wavelength of 1,550 nm so 0.459 μm produces one-λ thickness.

As example systems, structures that have either GaAs/AlAs and Si/SiO₂ layers for the mirrors of the top and bottom distributed Bragg reflectors, or combinations of these layers have been chosen.

For the GaAs/AlAs distributed Bragg reflectors, Nₜ is from 0 to 21, N_{b} is from 1 to 25, so the highest reflectivity of the top and bottom distributed Bragg reflectors is about 0.9982, which is achievable in reality. For the Si/SiO₂ distributed Bragg reflectors, Nₜ=N_{b} is from 0 to 4 and the highest reflectivity is 0.99895, see FIG. 6, which illustrates plots of reflectivity against the number of period for gallium arsenide and aluminium arsenide mirrors and silicon/silicon dioxide mirrors. In FIG. 6 reflectivity is plotted on the Y-axis and the number of periods, in other words, the number of mirror pairs of the distributed Bragg reflectors is plotted on the X-axis. The full line A of FIG. 6 represents the plot of reflectivity against the number of period for a top gallium arsenide/aluminium arsenide distributed Bragg reflector, while the broken line B of FIG. 6 illustrates a plot of the reflectivity against the number of period of a gallium arsenide/aluminium arsenide bottom distributed Bragg reflector and the chain line C of FIG. 6 represents a plot of the reflectivity against the number of period of top and bottom silicon/silicon dioxide distributed Bragg reflectors. From FIG. 6 the effective optical length of the microcavity can be deduced.

FIG. 7 illustrates a plot of the effective optical length in microns against the number of period of the Bragg reflectors. In FIG. 7 the effective optical length in microns is plotted on the Y-axis, and the number of periods, in other words, the number of mirror pairs of distributed Bragg reflectors, is plotted on the X-axis. The full line A of FIG. 7 is a plot of the effective optical length against number of period for a top distributed Bragg reflector of gallium arsenide/aluminium arsenide. The broken line B of FIG. 7 is a plot of the effective optical length against number of period for a bottom distributed Bragg reflector of gallium arsenide/aluminium arsenide, while the chain line C of FIG. 7 is a plot of the effective optical length against number of period for top and bottom distributed Bragg reflectors of silicon/silicon dioxide. Accordingly, it can be seen from FIG. 7 that with an Si/SiO₂ mirror pairing for the top and bottom distributed Bragg reflectors, the effective cavity length is much less than when the distributed Bragg reflectors are of gallium arsenide/aluminium arsenide mirror pairings. Accordingly, FIG. 7 would suggest that distributed Bragg reflectors of silicon/silicon dioxide mirror pairing produce a smaller cavity lifetime for a given reflectivity.

The two-photon absorption inside the microcavity is proportional to the two-photon absorption enhancement factor achieved by the microcavity structure. In the following the two-photon absorption enhancement factor achieved is referred to as the nominal two-photon absorption that can be achieved by the planar microcavity.

FIG. 8 illustrates a plot of maximised nominal two-photon absorption in arbitrary units against active layer thickness m, for three different incident pulse widths, where m is an integer value representing the thickness of the active layer. In FIG. 8 the number of periods is plotted on the Y-axis, while the active layer thickness m is plotted on the X-axis. The waveform A of FIG. 8 illustrates the plot for a pulse width of 0.13 picoseconds, the waveform B of FIG. 8 illustrates the plot for a pulse width of 1.0 picoseconds, while the waveform C of FIG. 8 illustrates the plot for a pulse width of 8.0 picoseconds. Thus, the waveforms of FIG. 8 show how the maximised normal two-photon absorption varies with active layer thickness m for the three different incident pulse widths, and from this it can be seen that in all cases there is an optimum active layer thickness which assists in designing the two-photon absorption photodetector.

In general, it is desirable that the reflectivity R_{b} of the bottom distributed Bragg reflector should be as high as possible. Thus, in the two-photon absorption photodetector of the computer simulation the bottom distributed Bragg reflector was chosen to have 24 mirror pairs of gallium arsenide/aluminium arsenide. It is known that the higher the reflectivity R_{b} of the bottom distributed Bragg reflector, the higher will be two-photon absorption enhancement factor under the condition that R=\sqrt{RₜR_{b}} is kept constant. Furthermore, if R is fixed, different combinations of the reflectivity Rₜ and R_{b} of the top and bottom distributed Bragg reflector combinations cause little variation on the effective optical length of the microcavity, and thus, little change of cavity lifetime and the two-photon absorption enhancement factor. Therefore, for a fixed value of R, R_{b} is kept as high as possible.

FIG. 9 illustrates a plot of number of period against active layer thickness m for top and bottom distributed Bragg reflectors for three pulse widths of 0.13 picoseconds, 1.0 picoseconds and 8.0 picoseconds. In FIG. 9 number of periods is plotted on the Y-axis, and the active layer thickness m is plotted on the X-axis. In FIG. 9 the top and bottom distributed Bragg reflectors are of gallium arsenide/aluminium arsenide mirror pairs, and the bottom distributed Bragg reflector is maintained constant with 25 mirror pairs, see waveform D. The waveform A of FIG. 9 shows the number of period of the top distributed Bragg reflectors plotted against the active layer thickness m for a pulse width of 0.13 picoseconds, the waveform B shows the number of period of the top distributed Bragg reflectors plotted against the active layer thickness m for a pulse width of 1.0 picoseconds, and the waveform C shows the number of period of the top distributed Bragg reflectors plotted against the active layer thickness m for a pulse width of 8 picoseconds. Thus, FIG. 9 shows that by increasing the active layer thickness, fewer mirror pairs are required for the top distributed Bragg reflector. There is thus a trade-off to be made between the number of mirror pairs and the active layer thickness.

FIG. 10 shows the normalised pulse full width half maximum and broadening factor of the auto-correlation trace plotted against active layer thickness m for pulse widths of 0.13 picoseconds, 1.0 picoseconds and 8.0 picoseconds. In FIG. 10 normalised pulse width full width half maximum and the broadening factor of the auto-correlation trace are plotted on the Y-axis, and the active layer thickness is plotted on the X-axis. The waveforms A and A′ of FIG. 10 illustrate the respective plots for a pulse width of 0.13 picoseconds, the waveforms B and B′ of FIG. 10 illustrate the respective plots for a pulse width of 1.0 picoseconds, while the waveforms C and C′ illustrate the respective plots for a pulse width of 8.0 picoseconds. It can be seen from FIG. 10 that the normalised pulse full width half maximum is around 1.0, and the broadening factor of the auto-correlation trace is around 1.9. Normalised pulse width of 1.0 indicates that the cavity resonance lifetime is approximately equal to the pulse width.

FIG. 11 illustrates a plot of maximised nominal two-photon absorption against active layer thickness m for top and bottom distributed Bragg reflectors of silicon/silicon dioxide and top and bottom distributed Bragg reflectors of gallium arsenide/aluminium arsenide mirror pairs for pulse widths of 0.13 picoseconds, 1.0 picoseconds and 8.0 picoseconds. Maximised nominal two-photon absorption is plotted on the Y-axis, and active layer thickness m is plotted on the X-axis. The waveforms A, B and C of FIG. 11 illustrate the plot for the top and bottom distributed Bragg reflectors of silicon/silicon dioxide for pulse widths of 0.13 picoseconds, 1.0 picoseconds and 8.0 picoseconds, respectively. The waveforms D, E and F of FIG. 11 illustrate the plot for the top and bottom distributed Bragg reflectors of gallium arsenide/aluminium arsenide for pulse widths of 0.13 picoseconds, 1.0 picoseconds and 8.0 picoseconds, respectively. Accordingly, FIG. 11 shows that in order to obtain the maximum two-photon absorption, the auto-correlation trace is broadened unavoidably. In other words, if the auto-correlation trace is not to be broadened, or is to be only slightly broadened, then the two-photon absorption effect must be sacrificed. Thus, there is a trade-off between two-photon absorption and the auto-correlation trace width.

Thus, it can be seen from FIG. 11 that for pulse widths of 0.13 picoseconds and 1.0 picoseconds, the top and bottom distributed Bragg reflectors of silicon/silicon dioxide mirror pairs achieve approximately six times enhancement relative to the top and bottom distributed Bragg reflectors of gallium arsenide/aluminium arsenide mirror pairs. Furthermore, the active layer thickness is of the smallest allowable value. However, the two-photon absorption enhancement achieved from the top and bottom distributed Bragg reflectors of silicon/silicon dioxide mirror pairs for pulse widths of 8.0 picoseconds drops to approximately three times the enhancement relative to the top and bottom distributed Bragg reflectors of gallium arsenide/aluminium arsenide mirror pairs.

From FIG. 11, it can also be seen that by providing the top and bottom distributed Bragg reflectors as silicon/silicon dioxide mirror pairs, more space is available to make the kind of trade-off identified by the waveforms of FIG. 9.

FIG. 12 illustrates a plot of the broadening factor of the auto-correlation trace plotted against the active layer thickness m for top and bottom distributed Bragg reflectors of silicon/silicon dioxide mirror pairs, and top and bottom distributed Bragg reflectors of gallium arsenide/aluminium arsenide mirror pairs for pulse widths of 0.13 picoseconds, 0.1 picoseconds and 8.0 picoseconds, respectively. Broadening factor of the auto-correlation trace is plotted on the Y-axis, and active layer thickness m is plotted on the X-axis. The waveforms A, B and C of FIG. 12 represent the plot for the top and bottom distributed Bragg reflectors of silicon/silicon dioxide mirror pairs for pulse widths of 0.13 picoseconds, 1.0 picoseconds and 8.0 picoseconds, respectively. The waveforms D, E and F of FIG. 12 represent the plot for the top and bottom distributed Bragg reflectors of gallium arsenide/aluminium arsenide mirror pairs for pulse widths of 0.13 picoseconds, 1.0 picoseconds and 8.0 picoseconds, respectively. It can therefore be seen from FIG. 12 that for top and bottom distributed Bragg reflectors of silicon/silicon dioxide mirror pairs, the variation of the broadening factor is larger than for top and bottom distributed Bragg reflectors of gallium arsenide/aluminium arsenide mirror pairs. The reason for this is that the reflectivity variation of the silicon/silicon dioxide mirror pairs caused by increasing or decreasing by one mirror pair is much larger than that for gallium arsenide/aluminium arsenide mirror pairs. Accordingly, from the above analysis, it can be shown that the higher the reflectivity of the bottom distributed Bragg reflector is the better. Thus, the highest reflectivity achievable for the gallium arsenide/aluminium arsenide mirror pair is taken to be 0.9982, and the highest reflectivity achievable for the silicon/silicon dioxide mirror pair is taken to be 0.99895. The effect of the reflectivity of the bottom distributed Bragg reflector on the maximised nominal two-photon absorption can now be detailed.

FIG. 13(a) is a plot of maximised nominal two-photon absorption against active layer thickness m for different values of reflectivity of the bottom distributed Bragg reflector for an 8.0 picosecond pulse, and FIG. 13(b) is a plot of maximised nominal two-photon absorption against active layer thickness m for different values of reflectivity of the bottom distributed Bragg reflector for a 1.0 picosecond pulse. In FIGS. 13(a) and (b) maximised nominal two-photon absorption is plotted on the Y-axis, and active layer thickness m is plotted on the X-axis. The reflectivity values of the bottom distributed Bragg reflector are given as (1−R_{b})×100%. Thus, FIGS. 13(a) and 13(b) show the effect of reflectivity of the bottom distributed Bragg reflector on the maximised nominal two-photon absorption. It can be seen from FIG. 13(a) that for an 8.0 picosecond pulse width, the influence of reflectivity of the bottom distributed Bragg reflector is very large, while the influence of the reflectivity of the bottom distributed Bragg reflector is considerably less for a 1.0 picosecond pulse. The reason for this is that in this particular case the reflectivity of the top distributed Bragg reflector is also very high, and thus a very small change of the reflectivity of the bottom distributed Bragg reflector causes a large change in the two-photon absorption.

A computer simulation of a hybrid structure in which the top distributed Bragg reflector is of silicon/silicon dioxide mirror pairs, and the bottom distributed Bragg reflector is of gallium arsenide/aluminium arsenide mirror pairs was prepared. Such a structure can be more easily fabricated in practice, and can produce better results than those which can be achieved by providing both the top and bottom distributed Bragg reflectors with gallium arsenide/aluminium arsenide mirror pairs in reducing the effective cavity length and the cavity lifetime.

FIG. 14 illustrates the maximised nominal two-photon absorption plotted against active layer thickness m for the hybrid structure in which the top distributed Bragg reflector comprises silicon/silicon dioxide mirror pairs and the bottom distributed Bragg reflector comprises gallium arsenide/aluminium arsenide mirror pairs for pulse widths of 0.13 picoseconds, 1.0 picoseconds and 8.0 picoseconds. For comparison, the results of top and bottom distributed Bragg reflectors comprising gallium arsenide/aluminium arsenide mirror pairs are also plotted in FIG. 14 for pulse widths of 0.13 picoseconds, 1.0 picoseconds and 8.0 picoseconds. Maximised nominal two-photon absorption is plotted on the Y-axis, and active layer thickness m is plotted on the X-axis. The waveforms A, B and C illustrate the plots for the hybrid structure for pulse widths of 0.13 picoseconds, 1.0 picoseconds and 8.0 picoseconds, respectively. The waveforms D, E and F illustrate the plots for the top and bottom Bragg reflectors both of gallium arsenide/aluminium arsenide mirror pairs for 0.13 picoseconds, 1.0 picoseconds and 8.0 picoseconds, respectively. For pulse widths of 0.13, 1.0 and 8.0 picoseconds, 70%, 50% and 40% enhancements, respectively, can be achieved.

FIG. 15 shows a plot of the number of periods plotted against active layer thickness m for the bottom distributed Bragg reflector and the top distributed Bragg reflector of the hybrid structure for pulse widths of 0.13 picoseconds, 1.0 picoseconds and 8.0 picoseconds. The number of period is plotted on the Y-axis and the active layer thickness m is plotted on the X-axis of FIG. 15. The bottom distributed Bragg reflector is of gallium arsenide/aluminium arsenide mirror pairs, and the number of periods in the bottom distributed Bragg reflector is maintained constant at twenty-five mirror pairs of silicon/silicon dioxide mirror pairs, see the waveform D of FIG. 15. The top distributed Bragg reflector is of silicon/silicon dioxide mirror pairs. The waveform A of FIG. 15 represents the plot of the number of periods against active layer thickness m for a pulse width of 0.13 picoseconds, while the waveform B of FIG. 15 represents the number of mirror pairs of the top distributed Bragg reflector plotted against the active layer thickness m for a pulse width of 1.0 picoseconds, while the waveform C of FIG. 15 represents a plot of the number of periods of the top distributed Bragg reflector plotted against active layer thickness m for a pulse width of 8.0 picoseconds. Thus, the number of mirror pairs of the bottom and top distributed Bragg reflectors required to achieve maximum nominal two-photon absorption can be seen from FIG. 15. As discussed above, the reflectivity of the bottom distributed Bragg reflectors is required to be as high as possible, and thus the number of mirror pairs selected for the bottom distributed Bragg reflector was twenty-five for the three pulse widths. Because of the large refractive index difference between the silicon/silicon dioxide mirror pairs of the top distributed Bragg reflector, much fewer mirror pairs are required in the top distributed Bragg reflector compared with the gallium arsenide/aluminium arsenide bottom distributed Bragg reflector.

FIG. 16 illustrates a plot of the broadening factor of the auto-correlation trace plotted against the active layer thickness m for the hybrid structure in which the top distributed Bragg reflector comprises silicon/silicon dioxide mirror pairs and the bottom distributed Bragg reflector comprises gallium arsenide/aluminium arsenide mirror pairs for pulse widths of 0.13 picoseconds, 1.0 picoseconds and 8.0 picoseconds. FIG. 16 includes corresponding plots for a structure in which both the top and bottom distributed Bragg reflectors comprise gallium arsenide/aluminium arsenide mirror pairs. The broadening factor of the auto-correlation trace is plotted on the Y-axis, and the active layer thickness m is plotted on the X-axis of FIG. 16. The waveforms A, B and C illustrate a plot of the broadening factor of the auto-correlation trace plotted against the active layer thickness m for the hybrid structure for pulse widths of 0.13 picoseconds, 1.0 picoseconds and 8.0 picoseconds, respectively, while the waveforms D, E and F represent the plots of the broadening factor of the auto-correlation trace against the active layer thickness m for the structure having top and bottom distributed Bragg reflectors of gallium arsenide/aluminium arsenide mirror pairs for pulse widths of 0.13 picoseconds, 1.0 picoseconds and 8.0 picoseconds, respectively. From the comparison of the waveforms in FIG. 16, an almost linear increase in the broadening factor with the active layer thickness m can be seen for the same number of mirror pairs in the top distributed Bragg reflector. The reason for this is that the increasing or decreasing by one of the number of mirror pairs of the top distributed Bragg reflector causes a large reflectivity variance, which causes the cavity resonance lifetime to continuously rise with the increase of the active layer thickness, which cannot be relieved by reducing the reflectivity of the top distributed Bragg reflector.

Referring now to FIG. 17, there is illustrated apparatus according to another embodiment of the invention, indicated generally by the reference numeral 50, for determining the pulse width of light pulses of an input repetitive light pulse signal of ultra-short pulsed light pulses. The apparatus 50 is substantially similar to the apparatus 1, 30 and 40 described with reference to FIGS. 1 to 4, and similar components are identified by the same reference numerals. The main difference between the apparatus 50 and the apparatus 1, 30 and 40 is in the two-photon absorption detector 51 of the apparatus 50. The two-photon absorption detector 51 is of similar general construction to that of the two-photon absorption detector 2 of the apparatus 1, 30 and 40, however, in the two-photon absorption detector 51 the top and bottom distributed Bragg reflectors 5 and 6 are selected so that light of two different wavelengths when incident on the incident surface 8 at the same angle of incidence resonates in the microcavity 3 of the two-photon absorption detector 51. In this case the top and bottom distributed Bragg reflectors 5 and 6 are selected so that light of wavelengths of 1,510 nm and 1,520 nm, when incident normal on the incident surface 8 resonates. The top distributed Bragg reflector 5 has a reflectivity of 0.95, and comprises twenty-five mirror pairs of λ₀/4 gallium arsenide/aluminium arsenide. The bottom distributed Bragg reflector 6 has a reflectivity of 0.986, and comprises thirty-four mirror pairs of λ₀/4 gallium arsenide/aluminium arsenide. The spacing of the mirror pairs in the top distributed Bragg reflector 5 is 365 nm, and the spacing of the mirror pairs in the bottom distributed Bragg reflector 6 is 400 nm in order that light of two wavelengths at the same angle of incidence to the incident surface 8 resonates. Thus, in this case the mirror pair spacing is greater in the bottom distributed Bragg reflector 6 than in the top distributed Bragg reflector 5.

In this embodiment of the invention the active region 4 comprises a bulk active layer of gallium arsenide of length L of 458.9 nm.

Accordingly, the apparatus 50 is suitable for detecting an input repetitive light pulse signal and for determining the pulse width of the light pulses of the input light pulse signal of any wavelength within two predetermined ranges of wavelengths, one of the wavelength ranges being 1,475 nm to 1,510 nm, and the other predetermined range of wavelengths being 1,485 nm to 1,520 nm. Accordingly, as the angle of incidence at which light is incident on the incident surface 8 of the two-photon absorption detector 51 is increased from the normal, the wavelengths of light which resonate in the microcavity 3 of the two-photon absorption detector 51 decreases in one case from 1,510 nm to 1,475 nm, and in the other case from 1,520 nm to 1,485 nm. Thus, the apparatus 50 can be tuned to input light pulse signals of light of wavelength in the range of 1,475 nm to 1,510 nm and from 1,485 nm to 1,520 nm as the angle of incidence at which the input light pulse signal is directed at the incident surface 8 is increased from normal to either ±45° from normal.

In this embodiment of the invention the optical fibre cable 16 and the lens 17 is mounted on a single platform 31, similar to the platform 31 of the apparatus 30 of FIG. 3, and the platform 31 is swivelable around a central pivot axis 33 similar to the central pivot axis 33 of the apparatus 30 of FIG. 3. In this embodiment of the invention the input and reference light pulse signals are directed at the incident surface 8 of the two-photon absorption detector 51 by the optical fibre cable 16 and the lens 17. The input light pulse signal is applied to a first input optical fibre cable 52 and the reference light pulse signal is applied to a second input optical fibre cable 53. The reference light pulse signal is applied through the second input optical fibre cable 53 to a delay line 23, similar to the delay line 23 already described, and the delayed reference input light pulse signal is applied through an intermediate optical fibre cable 54 to a polarisation light combiner 20, which is similar to the polarisation light combiner 20 already described. The reference and input light pulse signals are combined in the polarisation light combiner 20, and in turn applied to the optical fibre cable 16. Since light of two different wavelengths when incident on the incident surface 8 of the two-photon absorption detector 51 resonate in the microcavity 3, provided the two wavelengths of the two light signals are incident on the incident surface 8 at the appropriate incident angle to resonate, the wavelength of the reference light pulse signal may be the same or different to the wavelength of the input light pulse signal provided that where the wavelength of the reference light pulse signal is different to the wavelength of the input light pulse signal, the wavelengths of the input and reference light pulse signals are such that both resonate in the microcavity 3 at the same angle of incidence on the incident surface 8.

The apparatus 50 is particularly advantageous for use as a high efficient cross-correlator. Since light of two different wavelengths resonates in the microcavity 3 of the two-photon absorption detector for the same incident angle on the incident surface 8, the apparatus 50 is suitable for use when the reference repetitive light pulse signal is derived from a source which is different to the source from which the input repetitive light pulse signal is derived, provided that the wavelengths of the input light pulse signal and the reference light pulse signal are matched so that both resonate in the microcavity 3 for the same angle of incidence. For example, if the input light pulse signal was of wavelength of 1,520 nm, and the reference light pulse signal was of wavelength of the order of 1,510 nm, the input and reference light pulse signals when combined after the reference light pulse signal had been passed through the delay line 23 would resonate in the microcavity 3 when directed normal at the incident surface 8.

A computer simulation of the reflectivity spectrum of the two-photon absorption detector 51 is illustrated in FIG. 18. In FIG. 18 reflectivity is plotted on the Y-axis and wavelength in nanometers is plotted on the X-axis. The reflectivity spectrum of FIG. 18 shows the normal stop band from 1,370 nm and 1,670 nm with two resonance dips at 1,510 nm and 1,520 nm, which correspond to the wavelengths of light which when normal on the incident surface 8 of the two-photon absorption detector 51 resonates in the microcavity 3. The double resonance results from the different spacings of the mirror pairs of the top and bottom distributed Bragg reflectors 5 and 6.

Referring now to FIGS. 19 to 21, there is illustrated a tuneable photodetector device according to the invention, indicated generally by the reference numeral 70, for detecting light pulses of ultra-short duration of different wavelengths within a predetermined range of wavelengths. The photodetector 70 is particularly suitable for detecting ultra-short light pulses of a repetitive light pulse signal of a wavelength within the predetermined range of wavelengths. In this embodiment of the invention the photodetector device 70 is suitable for detecting light pulses of wavelengths within a predetermined range of wavelengths of 1,478 nm to 1,512 nm, and of pulse width of femtosecond and picosecond range, and typically in the 1 picosecond to 100 picosecond range at repetition rates in the 10 GHz to 160 GHz range. The photodetector 70 comprises a planar semiconductor two-photon absorption detector 73 which is provided in the form of a microcavity 74. The two-photon absorption detector 73 is mounted on a rotatable platform 75 which is rotatable through 90° about a central rotational axis 76 for facilitating varying the angle of incidence at which an input repetitive light pulse signal is directed at the two-photon absorption detector 73, as will be described below.

The two-photon absorption detector 73 comprises an active region 78 located between spaced apart first and second reflecting means, namely, a first distributed Bragg reflector 79 and a second distributed Bragg reflector 80. The first distributed Bragg reflector 79 defines a planar incident surface 82 through which light incident on the incident surface 82 passes into the active region 78. The active region 78 and the first and second distributed Bragg reflectors 79 and 80 are arranged so that light of wavelengths within the predetermined range of wavelengths resonates within the microcavity 74 to produce a detectable photocurrent is produced as a result of the two-photon absorption effect. Furthermore, the active region 78 and the first and second distributed Bragg reflectors 79 and 80 are selected and arranged so that when a light pulse of the maximum wavelength of the predetermined range of wavelengths, namely, a light pulse of 1,512 nm, is incident normal on the incident surface 82, the light of the light pulse resonates within the microcavity 74, the photocurrent resulting from the two-photon absorption effect is produced. Electrodes 84 and 85 on the first and second distributed Bragg reflectors 79 and 80, respectively, are provided for collecting the photocurrent. The two-photon absorption detector 73 is located on the platform 75 so that the axis 76 about which the platform is rotatable through 90° is contained in a plane defined by the incident surface 82 and extends centrally through the incident surface 82.

A light directing means comprising an optical fibre cable 87 and a lens 88, which is fixed relative to the rotatable platform 75 directs the input repetitive light pulse signal centrally at the incident surface 82 adjacent the central axis 76. The input light pulses of the input repetitive light pulse signal are the pulses to be detected if the wavelength of the light of the light pulses is of a desired wavelength within the predetermined range of wavelengths. In this embodiment of the invention the input repetitive light pulse signal is applied directly to the optical fibre cable 87.

The optical fibre cable 87 and the lens 88 direct the input light pulse signal at the incident surface 82 in a plane parallel to the platform 75 and in a plane perpendicular to the platform 75 containing the central rotational axis 76 of the platform 75. Additionally, the optical fibre cable 87 and the lens 88 are located relative to the platform 75 so that when the platform 75 is rotated into a central position, illustrated in FIG. 20, halfway between its two extreme positions, the input light pulse signal is incident normal on the incident surface 82. Accordingly, by rotating the platform 75 in either direction from its central position, the angle of incidence at which the input light pulse signal is directed at the incident surface 82 is varied through angles θ up to +45° and −45° from the normal, for facilitating detection of input light pulses of different wavelengths within the predetermined range of wavelengths.

By varying the angle of incidence θ at which the input light pulse signal is incident on the incident surface 82, the wavelength of the incident light which resonates within the microcavity 74 of the two-photon absorption detector 73 varies. The wavelength of light which resonates in the microcavity 74 decreases as the angle of incidence θ at which the input light pulse signal is directed at the incident surface 82 increases from the normal. Accordingly, in this embodiment of the invention the two-photon absorption detector 73 is provided so that light of the maximum wavelength of the predetermined range of wavelengths resonates in the microcavity 74 when the input light pulse signal is incident normal on the incident surface 82, and thus the minimum wavelength of the predetermined range of wavelengths is determined by the wavelength of light which resonates in the microcavity 74 when the input light pulse signal is directed at the incident surface 82 at the maximum incident angle θ of ±45° from the normal. Whether the incident angle θ is +45° or −45° does not alter the value of the minimum wavelength at which light resonates in the microcavity 74.

In this embodiment of the invention, as mentioned above, the photodetector device 70 is suitable for detecting light of wavelengths in the range of 1,478 nm to 1,512 nm. Thus, the active region 78 and the first and second Bragg reflectors 79 and 80 are selected and arranged so that light of wavelength of 1,512 nm resonates in the microcavity 74 when the light is incident normal on the incident surface 82. The minimum wavelength of the predetermined range of wavelengths in this case is 1,478 nm, since the angle through which the platform 75 is rotatable from the central position illustrated in FIG. 20 is ±45°. If the angle through which the platform 75 is rotatable was greater than ±45°, then the minimum wavelength of the predetermined range would be lower.

The active region 78 of the two-photon absorption detector 73 is of length L measured perpendicularly between the first and second distributed Bragg reflectors 79 and 80, which in this case is 458.9 nm, which is a fraction function of the maximum wavelength of the predetermined range of wavelengths. In this embodiment of the invention the refractive index of the active region 78 is 3.295, and thus, the maximum wavelength of 1,512 nm divided by the refractive index of 3.295 produces the length L of 458.9 nm. The active region 78 comprises a bulk alloy composition of aluminium, gallium and arsenide. However, the active region 78 may comprise a plurality of active layers provided by quantum wells which would be separated by barrier layers, and each active layer, typically, would be an alloy composition of aluminium, gallium and arsenide, and each barrier layer would be of an alloy composition of aluminium, gallium and arsenide. The cavity resonance, full width half maximum (FWHM) of the microcavity 74 is 4.2 nm with a finesse of 96.

The first distributed Bragg reflector 79 is of reflectivity of approximately 0.95, and comprises ten λ₀/4 gallium arsenide/aluminium arsenide mirror pairs, λ₀ being the cavity mode wavelength at normal incidence, which in this case is 1,512 nm. The second distributed Bragg reflector 80 is of reflectivity of approximately 0.986, and comprises eighteen λ₀/4 gallium arsenide/aluminium arsenide mirror pairs. Accordingly, the photodetector device 70 according to this embodiment of the invention is suitable for detecting light pulses of an input repetitive light pulse signal of wavelength in the range of 1,478 nm to 1,512 nm and of pulse width in the range of 1 picosecond to 100 picoseconds at a repetition rate of 10 GHz to 160 GHz.

A monitoring means, in this embodiment of the invention a monitoring circuit 93 illustrated in block representation in FIGS. 20 and 21, is coupled to the electrodes 84 and 85 for monitoring the photocurrent developed by the two-photon absorption effect in the microcavity 74. The monitoring circuit 93 comprises a standard lock-in amplifier which measures the photocurrent produced by the two-photon absorption detector 73 in response to the light pulses resonating in the microcavity 74.

In use, the input repetitive pulse light signal of the ultra-short input light pulses, which is to be analysed to ascertain if the input light pulses are of a desired wavelength, is applied to the optical fibre cable 87. The input light pulse signal is directed by the optical fibre 87 and the lens 88 at the incident surface 82. The photodetector device 70 is tuned by rotating the platform 75 about the central axis 76, and the platform 75 is set relative to the optical fibre cable 87 so that the angle of incidence θ to the normal at which the input light pulse signal is directed at the incident surface 82 by the optical fibre cable 87 and the lens 88 corresponds with the wavelength of light of the input light pulses which are to be detected. Thus, if the wavelength of the input light pulses which are to be detected is 1,512 nm, the platform 75 is set relative to the optical fibre cable 87 and the lens 88 so that the input light pulse signal is incident normal on the incident surface 82. On the other hand, if the wavelength of the input light pulses which are to be detected is 1,478 nm, the platform 75 is set relative to the optical fibre cable 87 and the lens 88 so that the input light pulse signal is incident on the incident surface 82 at an angle of incidence θ of either +45° or −45° from the normal. If, however, the wavelength of the input light pulses which are to be detected is of a wavelength lying between 1,478 nm and 1,512 nm, the platform 75 is set relative to the optical fibre cable 87 and the lens 88 so that the input light pulse signal is incident on the incident surface 82 at the angle of incidence θ which corresponds to that wavelength. Thus, when the input light pulses are of the wavelength corresponding to the wavelength to which the photodetector device 70 is tuned, the light of the light pulses of the input light pulse signal resonates in the microcavity 74, thereby producing corresponding pulses of photocurrent, which are detected by the monitoring circuit 93, which thus confirms that the input light pulses are of the wavelength to be detected.

The photodetector device 70 may also be operated as apparatus for analysing an input repetitive light pulse signal of ultra-short input light pulses to determine the wavelength of the input light pulses, provided the input light pulse signal is of wavelength within the predetermined range of wavelengths to which the photodetector device 70 can be tuned. In this case the input light pulse signal is applied to the optical fibre cable 87 of the photodetector device 70, and is directed by the optical fibre cable 87 and the lens 88 at the incident surface 82. The photodetector device 70 is tuned to the wavelength of the light of the light pulses of the input light pulse signal by rotating the platform 75 about the central axis 76 from the central normal position until a pulsed photocurrent resulting from light pulses of the input light pulse signal resonating in the microcavity 74 detected by the monitoring circuit 93 is of maximum value. When the value of the photocurrent pulses peak, the angle through which the platform 75 has been rotated from the central normal position is recorded. The wavelength of the input light pulses can be readily determined from a look-up table in which wavelengths are cross-referenced with corresponding angles of incidence of light incident on the incident surface 82 of the two-photon absorption detector 73. In this case the monitoring circuit would be equipped with a memory and a suitable look-up table would be stored in memory. A servomotor or a stepper motor would be provided for rotating the platform 75 from normal, and the monitoring circuit would read the angle through which the platform 75 was rotated from normal when the value of the photocurrent pulses is maximum. The appropriate wavelength corresponding to the angle through which the platform 75 had been rotated from the normal would be read from the look-up table.

Experiments have been carried out on the photodetector devices similar to the photodetector device 70 described with reference to FIGS. 19 to 21 to analyse the relationship between the cavity resonance wavelength of the microcavity of the two-photon absorption detector with angle of incidence of light on the incident surface, and also to analyse the relationship between the two-photon absorption response of the two-photon absorption detector with the angle of incidence of light on the incident surface. Computer simulations of a photodetector device similar to the photodetector device 70 were also made, and the relationship between the cavity resonance wavelength of the microcavity of the two-photon absorption detector with angle of incidence of light on the incident surface, and the relationship between the two-photon absorption response with angle of incidence of light on the incident surface were analysed. FIG. 22 illustrates the results of the analysis of the relationship between the cavity resonance wavelength of the microcavity of the two-photon absorption detector with angle of incidence, and FIG. 23 illustrates the relationship between the two-photon absorption response and the angle of incidence. In FIG. 22 the cavity resonance wavelength in microns is plotted on the Y-axis, and the angle of incidence in degrees is plotted on the X-axis. In FIG. 23 the two-photon absorption response is plotted on the Y-axis in arbitrary units, and the incident angle is plotted on the X-axis. The results illustrated in FIG. 22 were obtained from a two-photon absorption detector identical to that described in the photodetector device 1, with a microcavity identical to that of the photodetector device 1, the resonant wavelength at normal incidence was 1,512 nm. The curve A of FIG. 22 shows the relationship between the cavity resonance wavelength and incidence angle produced by the computer simulation, and the dots B are the values obtained from the experiments on the photodetector device. The resonance wavelength at normal incidence for the two-photon absorption detector, as can be seen from FIG. 22 at normal incidence, namely, the incident angle θ equal to zero is 1,512 nm. As the angle of incidence θ increases from normal, the resonance wavelength decreases to 1,475 nm.

The agreement between the experimental results represented by the dots B, and the computer simulation represented by the curve A of FIG. 22 is remarkably close. In the photodetector device 70, a tuning range of 34 nm was achieved from 1,512 nm down to 1,478 nm by rotating the platform 75 through 45° from the central position with the input and reference light pulse signals incident normal on the incident surface 82 to +45° with the input and reference light signals incident at an angle of 45° from normal on the incident surface 82. However, it will be readily apparent to those skilled in the art that by increasing the angle through which the platform 75 of the photodetector device 70 can be rotated, or by arranging the two-photon absorption detector 73 on the platform 75 so that by rotating the platform 75 through 90° or through angles greater than 90°, the angle of incident at which the input and reference light pulse signals are incident on the incident surface 82 can be increased beyond 45° from the normal, the tuning range of the photodetector device 70 according to the invention can likewise be increased. It is envisaged that by increasing the angle through which the platform 75 can be rotated so that angles of incidence of up to 75° or ±75°, the tuning range could be considerably increased above 34 nm. However, it is envisaged that at angles of incidence greater than 75°, the accuracy of the results would fall off due to the difficulty of directing sufficient light into the microcavity for incident angles greater than 75°.

However, even with a tuning range of 34 nm, the photodetector device according to the invention covers more than forty channels for a dense wavelength division multiplexing system used in optical telecommunications systems with repetition rates of 100 GHz in the 1,550 nm wavelength range.

Referring now to FIG. 23, the photodetector device on which the experiments were carried out to determine the relationship between the two-photon absorption response and incident angle was similar to the photodetector device 70 described with reference to FIGS. 19 to 21, with the exception that the cavity resonance wavelength at normal incidence was 1,566 nm. The computer simulation was carried out on a photodetector device having a similar two-photon absorption detector with a cavity resonance wavelength at normal incidence of 1,566 nm. The curve A of FIG. 23 represents the relationship between two-photon absorption response and incident angle produced by the computer simulation, while the dots B of FIG. 23 show the values obtained from the experiments. As can be seen from FIG. 23, the experimental results compare relatively closely with the curve A produced by the computer simulation, and as can also be seen from FIG. 23, the two-photon absorption response drops off from an arbitrary value of 1 at normal incidence to approximately 0.675 of the value at normal incidence when the incident angle is approximately 35°. At an incident angle of 45°, it is expected that the two-photon absorption response would be approximately half that obtained for normal incidence.

While the reference light pulse signal has been described with reference to the embodiments of the invention described with reference to FIGS. 1 to 3 as having been derived from the input light pulse signal, it will be appreciated that the reference light pulse signal may be derived from a source independent of the input light pulse signal. However, if the reference light pulse signal is derived from a source independent of the input light pulse signal, the input and reference light pulse signals could be cross-correlated, provided that the reference light pulse signal is of similar wavelength to that of the input light pulse signal. Otherwise, the reference and input light pulse signals would have to be directed to the incident surface of the two-photon absorption detector 2 by separate light directing means as has been described in connection with the apparatus 40 described with reference to FIG. 4, to ensure that the angles of incidence at which the respective input and reference light pulse signals are incident on the incident surface 8 are appropriate to their wavelengths, to ensure that the light pulses of the respective input and reference light pulse signals resonate in the microcavity 3.

It will be appreciated that the apparatus 30 and the apparatus 40 may be used for determining both the pulse width and the wavelength of an input light pulse signal, provided that the wavelength of the input light pulse signal is within a predetermined range of wavelengths within which the two-photon absorption detector 2 is responsive as a result of varying the angle of incidence at which the input light pulse signal is directed at the incident surface 8. The wavelength of the input light pulse signal would be determined by swivelling the platform 31 of the apparatus 30 or the first platform 45 of the apparatus 40 about the central pivot axes 33 and 47, respectively, until the pulsed photocurrent detected by the monitoring circuit 14 is of maximum value, at which stage the angle through which the platform 31 or the platform 45 has been swivelled from their respective central positions would be determined for determining the angle of incidence at which the input light pulse signal is incident on the incident surface 8, and the wavelength of the light of the input light pulse signal could then be read from a look-up table. The pulse width would be determined as already described with the platform 31 or the first platform 45 set relative to the two-photon absorption photodetector 2 at the angle which produces the pulsed photocurrent of maximum value. It is envisaged that the monitoring circuit 14 would also include a memory in which a look-up table with angles of incidence cross-reference with corresponding wavelengths, and a servomotor could be provided for swivelling the respective platforms, and a rotary potentiometer or other suitable sensing means could be provided for detecting the angle through which the platform 31 or the first platform 45 had been swivelled about the central axis 33 or 47 for determining the angle of incidence which produced the pulsed photocurrent of maximum value. The monitoring circuit 14 would be programmed to look up the look-up table and the wavelength of the input pulse signal from the look-up table.

While the top and bottom distributed Bragg reflectors of the apparatus described with reference to FIGS. 1 to 4 and the photodetector devices have been described as being of silicon/silicon dioxide mirror pairs and gallium arsenide/aluminium arsenide mirror pairs, respectively, the top and bottom distributed Bragg reflectors may be of any other suitable materials and may be of other numbers of mirror pairs besides those described. It is envisaged that the mirror pairs of either or both the top and bottom distributed Bragg reflectors may be of aluminium oxide/silicon dioxide, aluminium arsenide/gallium arsenide or indium phosphate/gallium phosphate, or other such mirror pair materials. Additionally, it will be appreciated that other suitable first and second reflecting means besides distributed Bragg reflectors may be used.

Additionally, while in the embodiments of the apparatus and photodetector devices described with reference to the drawings the reflectivity of the bottom distributed Bragg reflector has been described as being greater than the reflectivity of the top distributed Bragg reflector, it will be appreciated that the reflectivity of the bottom distributed Bragg reflector may be less than, or indeed, similar to the reflectivity of the top distributed Bragg reflector.

It will also be appreciated that other suitable materials besides those described for the active region of the two-photon absorption detectors of the apparatus and photodetector devices may be used, and as discussed above, the materials of the active region, in general, will be selected depending on the wavelength or range of wavelengths of the light pulses the pulse width of which is to be determined.

It is also envisaged that where a reference light pulse signal is derived from a source other than the input light pulse signal, the reference light pulse signal may be directed into the microcavity through any other surface besides the incident surface, provided that the reference light pulse signal resonates within the microcavity.

It is also envisaged that by appropriately selecting the first and second distributed Bragg reflectors of the two-photon absorption detectors, the two-photon absorption detectors could be provided so that light of three or more wavelengths would resonate in the microcavity of the two-photon absorption detectors for the same angle of incidence.

While the platforms on which the two-photon absorption detectors of the photodetector device according to the invention has been described as being rotatable from a central position corresponding to normal incidence of light on the incident surface in two angular directions, in certain cases, it is envisaged that the two-photon absorption detector may be mounted on the platform of the photodetector device, whereby in one extreme position of the platform, light would be incident normal on the incident surface of the two-photon absorption detector, and in the other extreme position of the platform, light would be incident at the maximum angle of incidence from the normal.

While the photodetector device of FIGS. 19 to 21 has been described for either determining the wavelength of an input light pulse signal of wavelength within a predetermined range of wavelengths, or for detecting an input light pulse signal of a predetermined wavelength within a predetermined range of wavelengths, it will be readily apparent that the photodetector device of FIGS. 19 to 21 could also be used for determining the pulse width of a light pulse of an input light pulse signal of ultra-short pulses if the photodetector device were provided with a light directing means for directing the input light pulse signal and a reference light pulse signal into the microcavity, and furthermore, if a delay means was provided for progressively delaying one of the reference and input light pulse signals relative to the other for alternately bringing the pulses of the respective input and reference light pulse signals into and out of phase with each other.

It will also be appreciated that while the active regions of the respective two-photon absorption detectors have been described as being of bulk semiconductor material, it is envisaged that the active regions may be of quantum well layer/barrier layer construction, or quantum dot construction. Needless to say, any other suitable construction of active region could be used.

While the apparatus and the photodetector device described with reference to the drawings have been described for determining the pulse width of an input light pulse signal, and for determining the wavelength of an input light pulse signal, and also for detecting an input light pulse signal of a predetermined wavelength, in all cases the input light pulse signals must of wavelength within specific predetermined ranges of wavelengths, it will be readily apparent to those skilled in the art that the apparatus and photodetectors may be provided for determining the pulse width and the wavelengths and for detecting input light pulse signals of the determined wavelengths within any desired range of wavelengths, and such apparatus and photodetectors would be adapted to operate within desired predetermined ranges of wavelengths by appropriately constructing the two-photon absorption detector, so that the range of resonance wavelengths of the microcavity corresponded with the desired predetermined range of wavelengths.

It will also be appreciated that the apparatus for determining the pulse width of light pulses of an input light pulse signal which have been described with reference to FIGS. 1 to 4 may also be used for determining the wavelength of ultra-short light pulses of an input light pulse signal, or for detecting an input light pulse signal of ultra-short light pulses, and where the apparatus of FIGS. 1 to 4 is to be so used, a reference light pulse signal would not be required.

1-194. (canceled)

195. Apparatus for determining the pulse width of light pulses of an input repetitive light pulse signal of repeating ultra-short light pulses, the apparatus comprising a two-photon absorption photodetector, the two-photon absorption photodetector being provided in the form of a microcavity comprising an active region and spaced apart first and second reflecting means between which the active region is located, and within which light resonates to produce a photocurrent as a result of the two-photon absorption effect, the active region and the first and second reflecting means being adapted so that the resonating lifetime of light in the microcavity is less than the pulse width of the light pulses, the pulse width of which is to be determined, a light directing means for directing the input repetitive light pulse signal into the microcavity for resonating therein, and for directing a reference repetitive light pulse signal of ultra-short repeating light pulses into the microcavity for resonating therein, and a means for progressively altering the phases relative to each other at which the light pulses of the respective input and reference light pulse signals enter the microcavity to produce a pulsed photocurrent from which the pulse width of the light pulses of the input light pulse signal is determined.

196. Apparatus as claimed in claim 195 in which the active region and the first and second reflecting means are adapted so that the resonating lifetime of light in the microcavity is in the range of 0.1 to 0.9 times the pulse width of the light pulses the pulse width of which is to be determined.

197. Apparatus as claimed in claim 196 in which the active region and the first and second reflecting means are adapted so that the resonating lifetime of light in the microcavity is in the range of 0.4 to 0.9 times the pulse width of the light pulses the pulse width of which is to be determined, and preferably, the active region and the first and second reflecting means are adapted so that the resonating lifetime of light in the microcavity is approximately 0.9 times the pulse width of the light pulses the pulse width of which is to be determined.

198. Apparatus as claimed in claim 195 in which the reflectivity of the second reflecting means is greater than the reflectivity of the first reflecting means, and preferably, the reflectivity of the first reflecting means is in the range of 0.05 to 0.99, and advantageously, the reflectivity of the first reflecting means is in the range of 0.6 to 0.99, and ideally, the reflectivity of the first reflecting means is approximately 0.95 for light pulses, the pulse width of which is to be determined of the order of one picosecond duration, and preferably, the reflectivity of the second reflecting means is in the range of 0.05 to 0.99, and advantageously, the reflectivity of the second reflecting means is in the range of 0.8 to 0.99, and ideally, the reflectivity of the second reflecting means is approximately 0.985.

199. Apparatus as claimed in claim 195 in which the first and second reflecting means are provided as first and second distributed Bragg reflectors, and preferably, the first distributed Bragg reflector comprises in the range of 1 to 15 mirror pairs, and advantageously, each mirror pair of the first distributed Bragg reflector comprises a silicon/silicon dioxide mirror pair, and ideally, each mirror pair of the first distributed Bragg reflector comprises a gallium arsenide/aluminium arsenide mirror pair.

200. Apparatus as claimed in claim 199 in which the second distributed Bragg reflector comprises in the range of 1 to 25 mirror pairs, and preferably, the second distributed Bragg reflector comprises approximately 15 mirror pairs, and advantageously, each mirror pair of the second distributed Bragg reflector comprises a gallium arsenide/aluminium arsenide mirror pair, and ideally, each mirror pair of the second distributed Bragg reflector comprises a silicon/silicon dioxide mirror pair.

201. Apparatus as claimed in claim 195 in which the perpendicular length between the first and second reflecting means of the active region is adapted to be a function of the wavelength of the light pulses, the pulse width of which is to be determined, and preferably, the perpendicular length between the first and second reflecting means of the active region is a fractional function of the wavelength of the light pulses, the pulse width of which is to be determined, and advantageously, the active region is of a material such that light of wavelength of the light pulses, the pulse width of which is to be determined resonates in the microcavity, and preferably, the active region is of a bulk semiconductor material, and preferably, the active region comprises at least one quantum well layer, and preferably, the active region comprises a plurality of barrier layers with a quantum well layer disposed between adjacent barrier layers, and advantageously, the material of each barrier layer is an alloy composition of aluminium and gallium arsenide, and preferably, the material of each quantum well layer is an alloy composition of aluminium and gallium arsenide.

202. Apparatus as claimed in claim 195 in which the first reflecting means defines an incident surface, and the light directing means is adapted for directing at least the input light pulse signal into the microcavity through the incident surface, and preferably, the light directing means is adapted for directing the reference light pulse signal into the microcavity through the incident surface, and advantageously, the reference light pulse signal is selected to be of wavelength similar to the wavelength of the input light pulse signal, and the light directing means is adapted for directing the input and reference light pulse signals at the incident surface at similar incident angles, alternatively, the reference light pulse signal is selected to be of wavelength different to the wavelength of the input light pulse signal, and the light directing means is adapted for directing the reference light pulse signal at the incident surface at an angle of incidence different to the angle of incidence at which the input light pulse signal is directed at the incident surface, and preferably, the light directing means is adapted for directing the input light pulse signal at the incident surface at an angle of incidence corresponding to the angle of incidence at which light of the wavelength of the input light pulse signal resonates in the microcavity, alternatively, the light directing means is adapted for directing the reference light pulse signal at the incident surface at an angle of incidence corresponding to the angle of incidence at which light of the wavelength of the reference light pulse signal resonates in the micro cavity.

203. Apparatus as claimed in claim 202 in which one of the two-photon absorption detector and the light directing means is moveable relative to the other for varying the angle of incidence at which at least the input light pulse signal is directed at the incident surface for facilitating tuning of the apparatus for determining the pulse width of light pulses of input light pulse signals of wavelengths within a predetermined range of wavelengths, and preferably, the two-photon absorption photodetector is adapted so that light of the highest wavelength of the predetermined range of wavelengths resonates in the microcavity when incident normal to the incident surface, and advantageously, the two-photon absorption photodetector is moveable relative to the light directing means, alternatively, the light directing means is moveable relative to the two-photon absorption photodetector.

204. Apparatus as claimed in claim 203 in which the light directing means comprises a first light directing means for directing the input light pulse signal at the incident surface, and preferably, the first light directing means is moveable relative to the two-photon absorption photodetector.

205. Apparatus as claimed in claim 204 in which the light directing means comprises a second light directing means for directing the reference light pulse signal at the incident surface independent of the first light directing means, and preferably, the second light directing means is moveable relative to the two-photon absorption photodetector, and advantageously, a monitoring means is provided for monitoring the angle of incidence at which the input light pulse signal is incident on the incident surface, and is responsive to the pulsed photocurrent and the angle of incidence at which the input light pulse signal is directed at the incident surface for determining the wavelength of the input light pulse signal.

206. Apparatus as claimed in claim 195 in which the means for progressively altering the phases relative to each other at which the light pulses of the respective input and reference light pulse signals enter the microcavity comprises a delay means, and one of the input and reference light pulse signals is passed through the delay means prior to being directed at the microcavity, and preferably, the delay means is a variable delay means for progressively varying the delay to which the one of the input and reference light pulse signals are subjected, and advantageously, the delay means comprises a delay line, and preferably, the delay line is a variable delay line, and advantageously, the reference light pulse signal is passed through the delay means, and preferably, a polarisation light combiner is provided for combining the input and reference light pulse signals prior to being directed into the microcavity, and advantageously, the reference light pulse signal is derived from the input light pulse signal, and preferably, a polarisation light splitter is provided for splitting the reference light pulse signal from the input light pulse signal, and advantageously, the reference light pulse signal is selected so that the pulse width of the light pulses thereof is similar to the pulse width of the light pulses of the input light pulse signal, and preferably, the reference light pulse signal is selected so that the repetition rate of the light pulses thereof is similar to the repetition rate of the light pulses of the input light pulse signal, and advantageously, the reference light pulse signal is selected so that the pulse width of the light pulses thereof is different to the pulse width of the light pulses of the input light pulse signal, and preferably, the reference light pulse signal is selected so that the repetition rate of the light pulses thereof is a multiple value or a fraction value of the repetition rate of the light pulses of the input light pulse signal.

207. Apparatus as claimed in claim 195 in which the apparatus is adapted for determining the pulse width of light pulses of pulse width not exceeding 500 picoseconds, and preferably, the apparatus is adapted for determining the pulse width of light pulses of pulse width not exceeding 100 picoseconds, and advantageously, the apparatus is adapted for determining the pulse width of light pulses of pulse width in the range of 10 femtoseconds to 100 picoseconds.

208. Apparatus as claimed in claim 195 in which a monitoring means is provided for monitoring the pulsed photocurrent and for determining the pulse width of the light pulses of the input light pulse signal from the monitored pulsed photocurrent, and preferably, the monitoring means is responsive to the full width half maximum of the peak value of the pulsed photocurrent for determining the pulse width of the light pulses of the input light pulse signal.

209. A method for determining the pulse width of light pulses of an input repetitive light pulse signal of repeating ultra-short light pulses, the method comprising providing a two-photon absorption detector in the form of a microcavity, whereby the microcavity comprises an active region and spaced apart first and second reflecting means between which the active region is located, and within which light resonates to produce a photocurrent as a result of the two-photon absorption effect, selecting the active region and the first and second reflecting means so that the resonating lifetime of light in the microcavity is less than the pulse width of the light pulses, the pulse width of which is to be determined, directing the input repetitive light pulse signal into the microcavity for resonating therein, directing a reference repetitive light pulse signal of ultra-short repeating light pulses into the microcavity for resonating therein, and progressively altering the phases relative to each other at which the light pulses of the respective input and reference light pulse signals enter the microcavity to produce a pulsed photocurrent from which the pulse width of the light pulses of the input light pulse signal is determined.

210. A photodetector device for detecting light of any one of a plurality of wavelengths within a predetermined range of wavelengths of an input light pulse of ultra-short duration, the photodetector device comprising a two-photon absorption detector comprising an active region within which incident light resonates to produce a detectable photocurrent as a result of the two-photon absorption effect, the two-photon absorption detector defining an incident surface for receiving incident light therethrough to the active region, and a light directing means for directing the input light pulse into the active region through the incident surface, one of the light directing means and the two-photon absorption detector being moveable relative to the other for varying the angle of incidence at which the input light pulse is incident on the incident surface for determining the wavelength of the input light pulse to which the photodetector device is responsive, so that when the light of the input light pulse contains light of the determined wavelength, the light of the input light pulse resonates in the active region to produce the detectable photocurrent.

211. A photodetector device as claimed in claim 210 in which the two-photon absorption detector is provided in the form of a microcavity comprising the active region located between spaced apart first and second reflecting means for reflecting light within the microcavity to resonate therein.

212. A photodetector device as claimed in claim 211 in which the microcavity is adapted so that light of the longest wavelength of the predetermined range of wavelengths when incident normal to the incident surface resonates within the microcavity, and preferably, the microcavity is adapted so that light of at least two wavelengths within the predetermined range of wavelengths when incident on the incident surface at similar incident angles resonates simultaneously within the microcavity, and advantageously, the first and second reflecting means are adapted for determining the wavelengths of light which resonate within the microcavity, and preferably, at least one of the first and second reflecting means comprises a distributed Bragg reflector comprising a plurality of spaced apart reflecting layers, and advantageously, the second reflecting means comprises a distributed Bragg reflector comprising at least one mirror pair, and advantageously, the first reflecting means comprises a distributed Bragg reflector comprising at least one mirror pair.

213. A photodetector device as claimed in claim 211 in which the perpendicular length between the first and second reflecting means of the active region is a function of the wavelength of light of the maximum wavelength of the predetermined range of wavelengths, and preferably, the perpendicular length between the first and second reflecting means of the active region is a fraction function of the wavelength of light of the maximum wavelength of the predetermined range of wavelengths, and advantageously, the perpendicular length between the first and second reflecting means of the active region is 458.9 nm, so that light of wavelength of 1,512 nm incident normal to the incident surface resonates in the microcavity.

214. A method for detecting light of any one of a plurality of wavelengths within a predetermined range of wavelengths of an input light pulse of ultra-short duration, the method comprising providing a two-photon absorption photodetector having an active region within which light resonates to produce a detectable photocurrent as a result of the two-photon absorption effect, the two-photon absorption detector defining an incident surface for receiving incident light therethrough to the active region, and providing a light directing means for directing the input light pulse into the active region through the incident surface, and moving one of the light directing means and the two-photon absorption detector relative to the other for varying the angle of incidence at which the input light pulse is incident on the incident surface for determining the wavelength of the input light pulse to which the photodetector device is responsive, so that when the input light pulse contains light of the determined wavelength, the input light pulse resonates in the active region to produce the detectable photocurrent.
